(19) United States
(12) Patent Application Publication
(10) Pub. No.: US 2018/0297867 A1
(43) Pub. Date: Oct. 18, 2018

(54) PROCESSING INCLUDING A MEMBRANE AND GAS RECYCLING SYSTEM FOR FORWARD OSMOSIS WATER TREATMENT SYSTEMS USING SWITCHABLE POLAR SOLVENTS

(71) Applicant: Artesion, Inc., Federal Way, WA (US)

(72) Inventors: Karen Fleckner, Federal Way, WA (US); Michael K. Neylon, Federal Way, WA (US)

(21) Appl. No.: 15/534,939

(22) PCT Filed: Dec. 11, 2015
(86) PCT No.: PCT/US15/65322

§ 371 Date: Jun. 9, 2017

Related U.S. Application Data
(60) Provisional application No. 62/091,324, filed on Dec. 12, 2014.

(51) Int. Cl. C02F 1/44; B01D 61/02; B01D 61/14; B01D 61/36; B01D 61/58; B01D 65/02; C02F 1/00; B01D 69/12; B01D 61/00; B01D 69/02; C02F 103/06; C02F 103/08; C02F 103/34

(52) U.S. Cl. CPC C02F 1/445; C02F 2303/16; B01D 61/145; B01D 61/364; B01D 61/58; B01D 65/02; C02F 1/008; B01D 69/12; C02F 1/442; C02F 1/444; C02F 1/447; B01D 61/005; B01D 69/02; B01D 2317/08; B01D 2317/06; B01D 2317/04; B01D 2317/022; B01D 2311/2665; B01D 2311/18; B01D 2325/022; B01D 2325/36; B01D 2325/38; C02F 2103/06; C02F 2103/08; C02F 2103/34; C02F 2209/008; C02F 2209/02; C02F 2209/06; C02F 2209/40; C02F 2301/043; C02F 2303/18; B01D 61/027

(57) ABSTRACT

Provided is a forward osmosis membrane-based water treatment system (including water desalination) using a switchable polar solvent as the draw solvent that is switched through the addition and removal of carbon dioxide. Provided is the use of a membrane system that designed to operate within the chemistry and properties of switchable polar solvents to promote water draw through the forward osmosis membrane, and a method of removing and reintroducing carbon dioxide to the switchable solvent.

### CROSS-REFERENCE TO RELATED APPLICATIONS

This application claims benefit of priority under 35 U.S.C. § 119(e) of U.S. Ser. No. 62/091,324, filed Dec. 12, 2014, the entire contents of which is incorporated herein by reference in its entirety.

### FIELD OF THE INVENTION

The invention relates generally to a process for water purification including desalination, using a series of one or more forward osmosis membrane systems and more specifically to using switchable polar draw solvents, with a membrane system designed to operate with the chemistry and properties of the polar solvent material.

### BACKGROUND OF THE INVENTION

Clean water production from tainted to heavily-contaminated water sources has become a significant problem with increased population growth and climate change. Freshwater sources such as lakes, rivers, and ground water aquifers are significantly impacted during long-term drought conditions. Water conservation has become significant, putting limits on the use of potable water. There is a need to be able to use impure water sources to provide clean water in sustainable, energy-efficient manner. These impure sources include but are not limited to: seawater, surface and groundwater sources including those that are impaired (having various levels of contaminants or pollution), greywater, industrial and commercial wastewater, municipal wastewater including tertiary treated water, produced water from the oil and gas industry, and water used in mining and fracking.

There are several existing methods for water purification from a range of contaminated water sources that can produce clean water of varying purity. These methods can include thermal processes, such as evaporation and distillation, and membrane-based processes, such as filtration and reverse osmosis. Thermal processes are energy intensive, since they rely on the high-energy process of vaporizing water. Filtration processes are ideal to remove suspended solids from water streams but cannot directly remove ionic or some biological contaminants that are of small size.

Reverse osmosis has been used for many water purification processes. Contaminated feed water (the feed solution) contacts one side of a semi-permeable membrane, while the permeate of low salinity contacts the opposite site. The membrane allows the passage of water while rejecting most ions and suspended solids. The osmotic pressure differential between the permeate and feed solution will naturally draw water into the feed solution and further dilute the water rather than purify it. The application of hydraulic pressure works against the osmotic pressure differential, and forces the feed water through the membrane into the permeate. The maximum applied hydraulic pressure, the water flux (volume rate of water draw per area of membrane) and the rejection rate for impurities for reverse osmosis are functions of the membrane construction.

The hydraulic pressure required for reverse osmosis will depend on the degree of salinity in the feed water which affects its osmotic pressure. Tertiary treated water streams typically contain up to about 1,000 ppm (parts per million) of total dissolved solids (TDS), and will have an osmotic pressure of 1 to 3 atm. Reverse osmosis systems for these streams use hydraulic pressures of 7 to 10 atm. Seawater on average has about 3.5 wt % TDS, and will possess an osmotic pressure of around 25 to 30 atm; seawater reverse osmosis systems must operate from 50 to 60 atm of hydraulic pressure to be effective. There is a maximum practical limit for reverse osmosis systems. It becomes very difficult and costly to generate pressures greater than 60 atm in water systems, and requires more exotic materials for the membrane and its housing and the system piping. Reverse osmosis is effectively limited to contaminated water sources with salinity no greater than seawater. Further, reverse osmosis can only remove a limited quantity of water from feed streams; as water is removed, the feed becomes more concentrated, leading to a higher osmotic pressure differential that the hydraulic pressure cannot overcome. For example, only 45-50% of the water can be theoretically recovered from seawater by a reverse osmosis system due to the maximum pressure limitation. Effective recovery is lower than this, ranging from 35 to 45%.

A more efficient option for water purification is forward osmosis (FO). As with RO systems, a FO system uses a semi-permeable membrane, with the feed solution contacting one side of the membrane. The opposite side of the membrane is in contact with a draw solution that possesses a very high osmotic pressure through its chemical properties. The osmotic pressure differential between the draw and feed will drive water across the membrane into the draw solution, replacing the external hydraulic pressure required in RO. The effluent clean water is then recovered by separating it from the draw solution. The manner of how this separation is performed and the net energy-efficiency of the process will depend on physical and chemical nature of the draw solution. FO has the potential for better water recovery from contaminated streams due to the high osmotic pressure differential, and can exceed the feed water concentration limits in RO system. With the proper draw solution, FO can theoretically recover over 75% of the water from seawater on a single pass, and can handle contaminated streams with more than 200,000 ppm TDS (˜20 wt %).

FO systems can be used as both stand-alone purification systems and as components of larger water treatment systems. U.S. Pat. No. 8,216,474 describes the use of FO as a pre-treatment option for a larger desalination plant using an RO desalination system. The FO pre-treatment is used to dilute the seawater prior to the RO unit, which has been demonstrated to reduce operating costs under certain conditions; the FO uses the seawater as a draw solution against a secondary wastewater stream that possesses less salinity than seawater. Other water purification processes that incorporate FO include the treatment of landfill leachate, and for the treatment of recovered water from biomass generated by anaerobic digesters.

Common draw solutions for FO use highly soluble inorganic or organic salts as the draw solute in water. Their high solubility and ionic nature leads to large osmotic pressure differentials that can readily pull water from high salinity streams. Clean water recovery from these draw solutions use either thermal evaporative/distillation processes, or additional membrane processes including reverse osmosis or hybrid osmosis/membrane distillation methods. These processes are energy intensive, and can have higher energy requirements than using RO directly on the feed stream. Thus, FO systems using salt-based draw solutions are not considered energy-efficient. It has been proposed that hybrid FO systems, where FO is used as a pre-treatment or post-treatment to RO or other distillation/vaporization processes for high salinity water including seawater, can be more energy-efficient on a produced water basis.

FO systems can be more energy efficient by using novel draw solutions that do not require the vaporization of water to separate the draw solute from the water. Of interest to this invention are draw solutions using a class of materials that are considered switchable polar solvent materials through the addition of an ionizing agent. Carbon dioxide (CO2) is the preferred ionizing agent in the prior art.

Switchable polar solvent materials encompass a variety of chemical classes, though primarily are nitrogen-based compounds such as amines. Without the presence of the ionizing agent, these materials are hydrophobic, typically having low solubility or miscibility with water. When the ionizing agent is added, these compounds form highly soluble bicarbonate and carbamate ionic pairs in water which are polar and hydrophilic. Their high solubility and ionic nature increases the osmotic pressure of the draw solution. The switchable polar solvent material can be switched back to its non-ionic, non-polar state by dissociating the ionizing agent in a low-temperature (<90° C.), atmospheric process. The material then will become insoluble with the water, enabling its removal through low-energy processes. These reversible reactions where the ionizing agent is CO₂ are shown below, where R¹, R², and R³ represent various functional groups. The switchable amine is either a tertiary amine (R¹R²R³N) or a primary or secondary amine (R¹R²NH or R¹R²R³N where R³ is the hydrogen functional group).

Bicarbonate: R¹R²R³N+CO₂+H₂O [symbol] R¹R²R³NH⁺+HCO₃⁻ (1)

Carbamate: 2 R¹R²NH+CO₂ [symbol] _{R}¹R²NH₂⁺+R¹R²N—COO⁻ (2)

In a FO system with switchable polarity draw solutes, the draw solute is switched on by the addition of the ionizing agent prior to the membrane. After drawing water through the membrane, the diluted draw solution is regenerated by removing the ionizing agent, and then using available methods to separate the switchable draw solute from the produced water. Additional polishing steps may be required to purify the clean water to meet requirements and regulations, but these will be low-energy processes. The recovered ionizing agent and switchable draw solute are regenerated to form the concentrated draw solution, closing the draw solution loop. An example of such a system is illustrated in FIG. 1, described in detail below. Switchable draw solutes offer energy efficiency improvements over other FO draw solutes as the clean produced water is recovered by removing the solute from the water and without vaporizing or evaporating the water. These draw solutes may be referred to as thermolytic, as the process to dissociate the draw solute and the ionizing agent from the draw solution is enabled by thermal energy.

One of the first materials with this switchable polarity nature used for FO water treatment was ammonia (NH3) activated by CO2 as the ionizing agent, as taught by U.S. Patent Application 2012/0273417. The addition of CO2 can create aqueous ammonia based systems with high osmotic pressures greater than that of seawater. The ammonia and CO₂ can be separated from water through heating and gas stripping. The ammonia-based FO systems have been modeled and evaluated for energy efficiency, and are reported to have significant energy savings compared to RO systems when treating seawater. RO systems are estimated to consume 2.5 to 3.0 kW-hr per m³ of produced water, while ammonia-based FO systems are estimated to consume 0.5 to 0.8 kW-hr per m³ of produced water.’

A difficulty with the ammonia based system is that the ammonia ionization by CO2 will form both carbamate and bicarbonate forms in aqueous solution, with selectivity more towards the carbamate form as listed in Equation (2). The carbamate form comes about due to the available hydrogen on the anime center. In considering other amines, the carbamate reaction will also occur for primary and secondary amines, and is generally requires more energy to reverse than the bicarbonate form. Ammonia also remains soluble in water without the presence of CO2 due to hydrogen bonding with water, making it difficult to fully separate ammonia from water without additional energy. Tertiary amines, which lack this hydrogen, cannot readily undergo the carbamate reaction, selectively forming the bicarbonate species which requires less energy to dissociate and remove from the draw solution. Tertiary amines are generally of higher molecular weight and thus tend to be less soluble in water in their non-ionic form. Therefore, the desired switchable draw solutes are tertiary amines that are highly insoluble in water but form highly soluble bicarbonate forms when CO2 is added. Other primary and secondary amines may be effective draw solutes if the selectivity towards the carbamate reaction relative to the bicarbonate reaction can be kept low.

An additional issue with ammonia-CO2 forward osmosis systems is reverse salt flux, the amount of draw solute that passes through the membrane from the draw solution to the feed solution. Draw solutes with low molecular weights or small molecule sizes, like ammonia, can easily pass through FO membranes and will end up in the feed solution. It is necessary to do additional purification to remove the ammonia from the concentrated feed effluent for further use in some cases, for example in brine obtained from the FO treatment of seawater. A larger draw solute molecule will have more difficulty crossing through the FO membrane and reduce the reverse salt flux. Tertiary amines will possess a much larger molecular size than ammonia, and thus are preferred draw solutes over primary and secondary amines.

There have been three broad classes of switchable polar solvent materials that can be used as forward osmosis draw solutes based on tertiary amines identified in prior art. These classes are based on the normal state of matter at standard ambient conditions (25° C., 1 atm). There is discrepancy in the nomenclature of these classes in the prior art. The distinction between “solute”, “solvent”, or “additive” for these switchable polar solvent materials as part of forward osmosis water treatment systems is not consistent in their use and application. Draw solutions using these switchable polar solvents as draw solutes have been called both “switchable hydrophilicity solvents” (SHS) and “switchable polarity solvents” (SPS) in the prior art.' In this invention, the switchable materials are considered to be “solutes” or “draw solutes” unless otherwise indicated.

The three classes considered in this invention are:

1) Gas phase materials: U.S. Patent applications 2013/02478447 and 2014/0076810 teach the use of gas-phase switchable draw solutes for forward osmosis. These applications identify the gaseous trimethylamine (TMA) as having desired properties for FO water treatment. TMA normally has low solubility with water but forms the highly soluble trimethylammonium bicarbonate salt with the addition of CO₂. A 60 wt % solution of TMA-CO₂ in water has an osmotic pressure around 220-230 atm, making it an excellent candidate for FO from high salinity water sources. TMA can be removed alongside CO₂ from the diluted draw solution using gas stripping columns. Error! Bookmark not defined. While TMA is the preferred draw solute due to its lack of carbamate form and its small size, other gas phase amine materials exhibit the switching behavior and may also be desirable draw solutes.

2) Liquid phase materials: U.S. Patent application 2013/00485671 teaches the use of liquid-based switchable tertiary amines as forward osmosis draw solutions. Several potential liquid-phase tertiary amines have been identified that possess very low miscibility with water but readily form highly soluble bicarbonates when CO₂ is added. Error! Bookmark not defined. Such materials as taught include N,N-dimethylcyclohexylamine, and 1-cyclohexylpiperidine. These have demonstrated osmotic pressures as high as 700 atm. On dissociation and removal of CO₂, the liquid-phase amine returns to its immiscible state, creating two liquid phases between the amine and water. Gravity-driven processes can recover most of the liquid amine.”

3) Polymer materials: U.S. Patent application 2014/0076810 teaches the use of polymers as switchable draw solutes for forward osmosis. Non-ionic polymers with tertiary amine monomers can be suspended in water. On the addition of CO₂, the amine-based centers will capture the CO₂ as bicarbonate ions, creating an ionic system that will possess high osmotic pressure. As polymers, these materials are less prone to undergo reverse salt flux across the FO membrane, and once CO₂ is removed, can be readily separated through simple filtration methods like nano-filtration, depending on the polymer's size.’

The prior art relates to general forward osmosis systems that use these three classes of switchable draw solutes. Researchers have presented the results of lab-scale experiments and proposed configurations for FO systems for gas phase Error! Bookmark not defined. and liquid phase draw solutes, whiles others have completed preliminary experiments to judge the viability of switchable polymers as effective draw solutes in FO. Error! Bookmark not defined. These classes have been demonstrated using CO₂ as the ionizing agent as there is ample supply this non-toxic substance. Similar effectiveness is anticipated when using other ionizing agents such as SO₂, COS, and NO₂, but these are not as abundant or benign as CO₂. There are no commercially-available membranes for RO as that application is well understood and optimized. Present research in FO rely on commercially available RO membranes, most which are constructed from a thin permeable membrane layer (the active layer) atop a more porous structural support layer. The FO process using these types of membranes leads to internal concentration polarization (ICP) of the draw solute at the interface between the active and support layers. The ICP reduces the effective osmotic pressure differential between the draw and feed solutions, impacting membrane performance. There are also external concentration polarization (ECP) effects at the external surfaces of the membrane layers. ECP affects the osmotic pressure differential but to not as great a degree as the ICP. Both the ICP and ECP are impacted by the fluid properties and flow rates on both sides of the membranes, and can be easily perturbed by small changes in the fluid flow rates, fluid properties, and salinity of the feed and draw solution. Current FO membrane research seeks to find new membrane structures that reduce the impact of ICP and ECP on the osmotic pressure differential.

A further problem with using RO membranes for FO is the interrelation between the ease of water permeability and the rejection of salts in the feed solution. The desired properties of a good FO membrane would have high water permeability and high salt rejection, but most RO membranes result in a tradeoff between these properties. RO membranes with high permeability tend to allow more salt through, and membranes with high salt rejection often have poor water draw capacity. Membrane evaluation in FO systems is further complicated by the reverse salt flux, the passage of the draw solute components into the feed water. The reverse salt flux tends to increase with higher permeability, leading to loss of draw solute from the draw solution loop. This extends to another area of FO research to understand how to optimize these three parameters, alongside the ICP/ECP effects, in FO membrane design. FO systems using switchable draw solutions present further challenges with current RO membranes. The bulk of the identified draw solute amines that have switchable nature are moderate to strong bases, with pKa values of 9 or greater. The FO process desires highly concentrated solutions of switchable draw solutes which will be caustic, with pH values greater than 10. Many RO membranes cannot safely operate at the high pH levels, leading to degradation, breakthrough, and failure of the material in the membrane. RO membranes with the highest water permeability, constructed of organic materials like cellulose triacetate (CTA), tend to be least compatible with highly caustic switchable draw solutions. The more durable membranes in switchable draw solutes tend to have lower permeability thus are less desirable. Alternatively, high permeability membranes can be used with more dilute switchable draw solutes, but this reduces the effectiveness for the FO system as it limits the rate of water recovered and cannot be used to treat high salinity feed water streams up to 200,000 ppm total dissolved solids (TDS).

The goals for most membrane design of FO systems are to optimize material for water treatment that will work in a single membrane unit. This can be very challenging for optimizing water draw and salt crossover. With forward osmosis membrane systems, the draw solution will become more dilute as it progresses along the membrane as water permeates into the solution. This will reduce the osmotic pressure, the overall water flux and salt crossover as the fluid progresses along the length of the membrane, as well as the pH of switchable draw solutions. A single membrane material may not be able to handle the full range of pH values associated with highly concentrated draw solutions needed to treat a variety of severely impaired water streams and potential variations of salinity within the feed water stream. The rate of change of pH of the draw solution as a result of increased water from the feed that occurs along the length of the membrane can be used to discretize the process into smaller segments to match the optimal membrane type for performance of each segment. A durable membrane can be used where the draw solution is most concentrated and has a high pH, and then a less durable membrane can be used once the draw solution is more dilute and possesses a lower pH. The overall water flux can then be maximized by optimizing the membrane type for each discretized segment.

This invention addresses the issues of membrane performance and durability that can occur with FO systems using switchable draw solvents. The invention describes two primary concepts: the ability to configure two or more membranes to optimize the water draw performance, salt crossover, and material durability, and the ability to adjust the switchable draw solution concentration in response to internal and external conditions to maintain system performance. The intended overall impact of these two concepts is to produce the maximum overall clean water production as deployed in this system.

The first concept is a membrane cascade system using two or more membranes in a combination of serial and parallel configurations to match the caustic nature of the draw solution with increasing water recovery with the appropriate membrane type and thus optimize performance. This will promote a greater durability of the membranes with the highest water recovery. Parallel configurations are used to meet flow capacity, as commonly performed in existing RO systems. Serial configurations that discretize the overall water draw across two or more membranes are used to optimize overall water flux and membrane durability. For example, it can be advantageous to use both a high flux/low salt rejection membrane and a low flux/high salt rejection membrane to balance the flux and salt reject for large water recovery. This concept can be used to mitigate the material compatibility issues with switchable draw solutions, using durable, low-flux membranes only where the draw solution is most caustic, followed by high flux membranes once the draw solution is diluted to be compatible with the membrane.

The second concept is the ability to adjust the concentration of the draw solution in response to changes internal and external to the overall system. An FO system using switchable draw solutes will be designed to operate the draw solution between a concentrated form and a dilute form following water draw across the membrane system. Clean water effluent is obtained by extracting the draw solute and ionizing agent from the dilute draw solution. The concentrated draw solution is regenerated by reintroducing the draw solute and ionizing agent into water or diluted draw solvent. The ratio of draw solute and ionizing agent to the draw solution can be adjusted on the fly through this regeneration process. This enables the adjustment of the draw solution concentration to manage its properties such as pH or osmotic pressure. This adjustment can be used to mitigate changes that would otherwise impact the performance of the membrane without significantly affecting the flow rate of draw solution across the membrane. This adds to a consistent operation and maximization of the overall clean water effluent production. For example, secondary and tertiary treated water will have large fluctuations in its salinity which will impact its osmotic pressure and subsequently the water draw across the membrane. The water draw across the membrane can be maintained by adjusting the concentration of the draw solution in response to feed water changes. This ability is enabled by a control system that operates not only at the FO component level but across an entire water treatment system. This control system can meet the requirements needed for a supervisory control and data acquisition system (SCADA).

Both of these concepts will support improved FO membranes in the future, particularly those designed for switchable draw solutes, and can be optimized for cost-effectiveness based upon application requirements.

In addition to these concepts, this invention identifies other system and sub-system concepts to improve the energy efficiency and water recovery for switchable draw solute FO systems. This invention further identifies methods for draw solute recovery and regeneration that can lower the energy requirement for produced water compared to salt-based and ammonia-based FO systems. Another aspect of this invention describes post-processing that will be necessary to reduce the toxicity of the amine draw solutes and impurities from the feed water which will be present to trace amounts to meet safety, health, and economic requirements.

### SUMMARY OF THE INVENTION

The invention described herein is an overall water treatment system incorporating at least one forward osmosis (FO) water purification subsystem using a draw solution that incorporates a switchable draw solute. The invention relates generally to a process for water purification including desalination, using a series of one or more forward osmosis membrane systems and more specifically to using switchable polar draw solvents, with a membrane system designed to operate with the chemistry and properties of the polar solvent material. The membrane system can include many parallel membrane subsystems, each consisting of one or more membranes utilizing a serial and or a serial-parallel configuration with at least one membrane being inorganic or inorganic/organic combination, and a monitoring system to measure the performance of the individual membranes. The balance-of-plant uses a vacuum-driven recycle and monitoring design to regenerate the solvent while reducing the energy consumption. This vacuum recycle can include components to generate ultra-clean water from the process.

In one embodiment, the invention provides a water treatment system which operates on one or more impure water sources to produce one or more purified water effluents, utilizing one or more water treatment sub-systems including at least one water treatment system based on a forward osmosis process which includes:

an aqueous draw solution using a draw solute that become highly soluble and ionic on the addition of an ionizing agent, and becomes insoluble and non-ionic on the dissociation of the ionizing agent (a switchable draw solute or solvent);

a membrane process where impure feed solution contacts one side of at least one semi-permeable membrane, and the concentrated draw solution contacts the other side, and which water is drawn through the membrane from the feed solution into the draw solution through the difference in osmotic pressure between the draw and feed solution;

a recovery process where the diluted draw solution following the membrane process is treated to dissociate the ionizing agent from the draw solute, and subsequently remove the draw solute and the ionizing agent from the water, generating a clean water stream;

a regeneration process where the recovered draw solute and ionizing agent are reintroduced into aqueous solution, generating a concentrated draw solution prior to the membrane process; and

a control system that monitors and controls the individual processes within the forward osmosis water treatment sub-system.

### BRIEF DESCRIPTION OF THE DRAWINGS

FIG. 1 is a process flow diagram showing the general process used in the FO water treatment sub-system of this invention.

FIG. 2 is a process flow diagram showing the more preferred process used in the FO water treatment sub-system of this invention. This process flow diagram incorporates the embodiment with recovery bypass, and the embodiment of using makeup/blowdown process system when the draw solution can be stored in a concentrated form.

FIG. 3 is a process flow diagram showing the more preferred process used in the FO water treatment sub-system of this invention. This process flow diagram incorporates the embodiment with recovery bypass, and the embodiment of using makeup/blowdown process system when the draw solution cannot be stored in its concentrated form and instead is made up from the switching material and ionizing agent.

FIG. 4 is a process flow diagram showing the embodiment of the recovery process of the FO water treatment sub-system of this invention when the switchable draw solute is nominally in a gas state at standard ambient conditions.

FIG. 5 is a process flow diagram showing the embodiment of the recovery process of the FO water treatment sub-system of this invention when the switchable draw solute is nominally in a liquid state at standard ambient conditions.

FIG. 6 is a process flow diagram showing the embodiment of the recovery process of the FO water treatment sub-system of this invention when the switchable draw solute is nominally a polymer at standard ambient conditions.

FIG. 7 is a process flow diagram showing the embodiment of the recovery process and regeneration process of the FO water treatment sub-system of this invention when a vacuum pump is applied to the recovery process.

FIG. 8 is a process flow diagram showing the embodiment of the recovery process and regeneration process of the FO water treatment sub-system of this invention when an ejector is used to create a vacuum applied to the recovery process.

FIG. 9 is a process flow diagram showing the embodiment of the recovery process and regeneration process of the FO water treatment sub-system of this invention, demonstrating one method of heat reuse from the regeneration process and external heat sources into the recovery system.

FIG. 10 is a process flow diagram showing the embodiment of the membrane process, in which multiple membrane units are configured in a parallel manner. This is an example of this embodiment showing four membrane modules, but any number of membranes may be used in this embodiment.

FIGS. 11a-11c show three process flow diagrams showing the embodiment of the membrane process, each demonstration one possible method of configuring membrane units in a serial manner. FIG. 11a demonstrates the basic serial configuration where the feed and draw solutions flow counter-current through the membrane units. FIG. 11b demonstrates the serial configuration where the draw solution is split, with each fraction passing through a smaller number of the membrane units. FIG. 11c demonstrates the serial configuration where the draw solution is split and injected into the draw solution flow path at several points on the serial configuration. These are representative examples of the serial configuration, and any number of membranes and different flow paths are possible.

FIGS. 12a-12b is a process flow diagram showing two possible embodiments of the membrane cascade in serial and parallel configurations. FIG. 12a shows the embodiment of the membrane process that uses a combined serial and parallel configuration, here showing two parallel membrane systems, each with four membrane units in series. FIG. 12b shows the embodiment of the membrane process that uses a combined serial and parallel configuration with two serial membrane systems, each possessing a bank of four membranes in parallel. These are representative examples of the combined serial and parallel configuration and other configurations and flow paths are possible, building on the previous examples from FIG. 10 and FIG. 11.

FIG. 13 is a process flow diagram showing the general configuration for the embodiment of the overall water treatment system that includes at least one switchable-FO water treatment sub-system.

FIG. 14 is a process flow diagram showing one preferred embodiment of the overall water treatment system which operates on a combination of industrial waste water and tertiary treated recycled water to produce clean water using a switchable FO water treatment sub-system. The produced water may be internally recycled to the industrial facility to offset tap water use

FIG. 15 is a process flow diagram showing one preferred embodiment of the overall water treatment system which operates on seawater to produce potable water, using a primary RO water treatment sub-system and a switchable FO sub-system to extract more water from the brine reject.

FIG. 16 contains two figures related to Example 2:

FIG. 16a is a graph demonstrating the benefit of the membrane discretization section in optimization of switchable FO membrane capabilities, and further described in more detail in Example 2 below. The example considering two membrane systems in parallel operation, one a low-flux membrane (LFM) with high salt reject, while the second membrane is a high-flux membrane (HFM) with lower salt reject. In this example, the draw solution enters the LFM first and then the HFM, while the feed solution, 3.5 wt % NaCl, is counter-current to that. The graph considers several configurations for the sizing of the two membranes to draw a fixed amount of water across the membranes, based on how much of that is done by the HFM, as shown on the bottom axis. The left axis is the various membrane areas that are required, based on calculations and assumptions on the performance of these membranes. These include the individual areas for the LFM (diamond), HFM (squares), and total membrane area (circles). The right axis (corresponding to the “X” points) is the salt content in the produced water for each case. The graph shows that there is a tradeoff between membrane area and the quality of the water produced by the process, and that discretizing the water recovery between two membranes can be more effective and reduce costs.

FIG. 16b is a graph demonstrating the membrane discretization approach when dealing with a caustic switchable draw solution. The curve on the graph shows the increase in pH of the switchable draw solution on the vertical axis as more water flux is demanded from the feed solution on the horizontal; larger water flux will require more concentrated draw solutions which will have high pH values. Three membranes of different types (1, 2, and 3) are used in series to treat the feed water with Type 1 the first to contact the diluted feed stream. Each membrane has different operating performance and compatibility with the caustic switchable draw solute, here represented by their maximum allowable pH for safe operation, given as pHM1, pHM2, and pHM3. In general, membranes with higher tolerance towards the draw solution will have poor water flux, and thus it is desirable to optimize the sizing of each membrane to minimize the membrane surface area while avoiding material compatibility issues. The sizing and design of the membrane operation is selected so that no membrane operates at a pH higher than its tolerance, and ideally somewhat lower than that tolerance level to improve durability. This creates the example discretization shown in FIG. 16b, staging the membranes along the curve as shown. This figure is further described in Example 2.

### DETAILED DESCRIPTION OF THE INVENTION

The invention relates generally to a process for water purification including desalination, using a series of one or more forward osmosis membrane systems and more specifically to using switchable polar draw solvents, with a membrane system designed to operate with the chemistry and properties of the polar solvent material.

A “water treatment system” is considered to be a system process composed of multiple treatment sub-systems that processes water from a source to produce a desired quality of water.

A “water treatment sub-system” is considered to be either a singular sub-system, or a set of water treatment sub-systems arranged in series or parallel configurations, along with supporting balance-of-plant equipment (valves, pumps, sensors, etc.) that handle one aspect of water treatment. For example, a RO water treatment sub-system may be composed of a pump, one or more RO membranes within their housing units, and pressure, flow rate, and temperature sensors located throughout the system to monitor performance.

A “primary water treatment sub-system” is defined as a singular sub-system or a parallel number of modules of the same water treatment type within the water treatment system which perform the largest removal of contaminants from the feed water with a high water recovery. For example, a typical RO system will include the RO sub-system (as described above), upstream filters to remove suspended particles, and an ultraviolet (UV) sterilizer system downstream to remove biological and organic materials. The RO unit remains the primary water treatment sub-system in this configuration as the primary removal of contaminants occurs there.

“Produced water” refers to the water generated by the water treatment system.

“Clean water” refers to the effluent water generated by the water treatment system. This effluent can be pure water, but not always.

“Recycled water” refers to water that is produced from secondary or tertiary treatment of wastewater. Such water often referred to as “reclaimed water” and “purple pipe water”.

“Impaired water” refers to surface water or groundwater sources which do not meet water quality standards that governments or authorities have set, even after point sources of pollution have installed the minimum required levels of pollution control technology, such as those defined under the U.S. Clean Water Act, section 303(d).

“Upstream” and “downstream” refer to the placement of sub-systems with respect to the flow of the feed water as it is purified, unless otherwise noted. The water sources are upstream of the water treatment system, while the produced water is collected downstream of the system.

A “switchable” material is a chemical component or mixture that, when in the presence of water, can impact the ionic nature of the water through the addition or dissociation of an ionizing agent. A switchable draw solute becomes more ionic when contacted by the ionizing agent, and becomes less ionic when the ionizing agent is removed.

A “switchable polar solvent”, unless otherwise clarified, is considered in this invention to be a draw solution that uses a switchable material.

An “ionizing agent” is a material that can provide a proton to ionize the switchable draw solute, while forming an anion itself. A common ionizing agent is CO2, but other gases like CS2, COS, NO2, SO2 and mixtures of these gases can also be used.

“Standard ambient conditions” refers to a temperature of 25° C. and a pressure of 1 atm.

“Organic compounds” defined here are molecules that primarily contain a carbon backbone chain and the presence of hydrogen, with, on average, at least one hydrogen molecule bonded to each carbon in the molecule. “Inorganic compounds” are molecules that otherwise do not meet this definition of “organic compound”, and can include carbon-based structures that lack hydrogen or have, on average, far less than one hydrogen bonded to each carbon in the molecule, such as graphite.

A “regeneration system” in the context of this invention is a set of processes that bring together water, draw solute, ionizing agent, and diluted draw solution to form the concentrated draw solution. This process is also referred to in prior art as a “gassing” system, as the ionizing agent, and in some cases the draw solute, are normally introduced as gases.

A “recovery system” in the context of this invention is a set of processes that separate the draw solute and the ionizing agent from the diluted draw solution to produce clean water. This process is also referred to in the prior art as a “degassing” system, as the ionizing agent, and in some cases the draw solute, are normally removed from the draw solute as gases.

Unless otherwise stated, a “draw solvent” refers to a draw solution in the membrane process which can readily accept the addition and remove of draw solute and other salts that may transfer from the feed solution into the draw solution. A “switchable draw solvent” is such a solution that uses a switchable material, as defined above.

### Detailed Description of the Invention

In the embodiment of this invention, the source water to be treated is a contaminated water stream that may include but not limited to: greywater, brackish water, seawater, surface and groundwater including impaired and polluted sources, brine, high-salinity bodies of water, secondary and tertiary treated wastewater (also commonly referred to as recycled water, reclaimed water or “purple pipe” water), biomass, municipal solid waste and associated leachate, pharmaceutical, food/beverage, and industrial process streams (for the processing and removal of water), industrial and commercial wastewater, agriculture, and produced water from oil & gas (hydro-fracturing), geothermal, and from mining operations. In a more preferred embodiment, two or more sources of water are processed by the water treatment system. In a more preferred embodiment, these sources include, at minimum, industrial and commercial wastewater and secondary and tertiary treated wastewater.

The water treatment system will produce clean water to the purity requirements of the application. In a preferred embodiment of this invention, the system will produce water that meets or exceeds the quality requirements for tertiary treated wastewater for the local area (approximately no greater than 1000 ppm TDS). In a more preferred embodiment, the system will produce water that meets or exceeds quality requirements for potable/tap water for the local area. The requirements of potable water vary by nation and state. The U.S. Environmental Protection Agency (EPA) has set a secondary standard for potable water as having less than 500 ppm TDS along with additional requirements on specific biological, organic, and inorganic content. In a preferred embodiment, the water treatment system can produce two or more clean water streams of differing standards, such as potable and tertiary-treated streams.

In the embodiment of this invention, one of the sub-systems in the water treatment system is a switchable FO sub-system. The switchable FO sub-system contains, at minimum, the following major unit operations:

a) A draw solution that uses a switchable material as its draw solute in aqueous solution, along with an ionizing agent that is used to enable the switching of the draw solute. (This is also considered as a “switchable polar solvent”).

b) A semi-permeable membrane or plurality of membranes that allow water to pass through but restrict passage of other chemical species, including ions, dissolved and suspended solids, and biological materials. Feed water, from which clean water will be produced from, contacts one side of the membrane(s) as the feed solution, while the draw solution contacts the opposite side of the membrane.

c) A recovery process to dissociate the ionizing agent from the switchable draw solute, returning it to its non-ionic form, and to subsequently remove both from the water as to produce a clean water effluent stream.

d) A regeneration process to contact the non-ionized switchable draw solute in solution with an ionizing agent to create a highly ionic draw solution.

e) A control system that monitors and controls the switchable FO sub-system.

### Draw Solute

In the embodiment of this invention, the draw solute is a material or combination of materials that normally in solution with water will possess low ionic strength (low osmotic pressure), and then can be reversible activated by an ionizing agent to form a solution with high ionic strength (high osmotic pressure). In a preferred embodiment of this invention, the switchable draw solute in its non-ionic state will not be highly soluble or miscible with water (hydrophobic), while in its ionic state (following activation by an ionizing agent) will have a high solubility or miscibility with water (hydrophilic).

Reverse salt flux of the draw solute through the membrane process into the feed solution will occur in FO systems. This is mitigated by using larger draw solute molecules (associated with the draw solute's molecular weight) which will be more difficult to pass through the membrane. In the embodiment of this invention, the draw solute has a molecular weight of at least 31 g/mol.

In the embodiment of this invention, the draw solute is amine of the general form R1R2R3N, or an amidine of the general form R1-C(═NR2)—NR3R4), or a guanidine of the general form R1R2-C(═NR3)—NR4R5). In these, R1, R2, R3, R4, and R5 are each independently selected from the following substitution groups: hydrogen, a substituted or unsubstituted alkyl group, including linear, branched, and cyclic components, with between one and 10 carbon atoms; a substituted or unsubstituted CnSim group (where n and m are integers independently selected from 0 to 10, and where (n+m) is an integer from 1 to 10); and a substituted or unsubstituted aryl group or heteroaryl group that may contain at least one {—Si(R6)2-O—} group, where R6 is a substituted or unsubstituted alkyl, aryl, heteroaryl, or alkoxy group. If the group is substituted, the substituent may be an alkyl, alkenyl, alkynl, alkyl halide, aryl, aryl halide, heteroaryl, non-aromatic ring, Si(alkyl)3, Si(alkoxy)3, alkoxy, amino, ester, amide, thioether, alkylcarbonate, or thioester group. The nitrogen may also be part of a heteroatom ring structure.

In the preferred embodiment of this invention, the draw solute is a tertiary amine R1R2R3N where none of R1, R2, or R3 are a hydrogen group.

In an embodiment of this invention, the draw solute may consist of two or more draw solute chemicals described above.

### Gas-Based Solute

In a preferred embodiment of this invention, the draw solute is a chemical that at standard ambient conditions (1 atm, 25° C.) is nominally in its gas phase, and has low solubility in water. The addition of the ionizing agent causes the gas to form a highly soluble salt in water; the dissociation of the ionizing agent returns the chemical to its non-ionic state where it vaporizes out of the water due to its low solubility. In this preferred embodiment, the non-ionic gas has a solubility of less than 0.1 g/ml in water, and in its ionic form, a solubility greater than 1.0 g/ml in water. In a more preferred embodiment, the non-ionic gas has a solubility less than 0.0001 g/ml in water. In a preferred embodiment, the gas is ammonia or trimethylamine.

For the gas-phase draw solute, a high Henry's constant in its non-ionic state is desirable. The high Henry's constant improves the separation of the draw solute in the recovery process. In this preferred embodiment using the gas-based switchable draw solute, the solute possesses a Henry's constant greater than 1×104 (Pa/mol-fraction) in the non-ionic state.

In this preferred embodiment, the gas-based draw solute is a tertiary anime R1R2R3N where R1, R2, and R3 are independently selected from functional groups as described previously excluding hydrogen. In the most preferred embodiment, the gas-based draw solute is trimethylamine. In another embodiment of this invention, the draw solute is a combination of two or more amines each nominally a gas state at standard ambient conditions.

### Liquid Phase

In another preferred embodiment of this invention, the draw solute is normally a liquid at standard ambient conditions, and belongs to a class of materials called switchable hydrophilicity solvents (SHS), sometimes called switchable polarity solvents (SPS). The liquid draw solute is immiscible with water (hydrophobic) without the present of an ionizing agent, but forms an ionic salt on the addition of an ionizing agent that is highly soluble (hydrophilic). When the ionizing agent is removed, the liquid draw solute returns to its hydrophobic state and will form a separate liquid phase from water. In this preferred embodiment, the draw solute in its hydrophobic form has a solubility of less than 0.1 g/ml in water, and in its hydrophilic form, a solubility greater than 1.0 g/ml in water. In a more preferred embodiment, the hydrophobic form of the draw solute has a solubility less than 0.0001 g/ml in water.

For effective removal of the draw solute from the diluted draw solution, the draw solute should stay as a liquid to avoid the energy cost of vaporizing the draw solute. In this preferred embodiment, the draw solute in either its ionic or non-ionic form possesses a boiling point greater than 100° C. at 1 atm.

In this preferred embodiment, the liquid draw solute is a tertiary amine of the form R1R2R3N where R1, R2, and R3 are independently selected from functional groups as described previously excluding hydrogen. In a preferred embodiment, the draw solute is a combination of two or more amines that are nominally a liquid state at standard ambient conditions.

### Polymer

In yet another preferred embodiment of this invention, the draw solute is a polymer with amine-based monomers. Without the ionizing agent, the polymer may either remain suspended in water in a non-ionic state, or may precipitate out. With the addition of the ionizing agent, active centers on the polymer chain interact with the ionizing agent to create charged pairs (for example, —[NH+]— centers paired with HCO3- ions); in this form, the polymer remains suspended in the water. In the preferred version of this embodiment, the polymer in its non-ionic form is at least 100 um in average diameter and remains suspended in solution, and when in its ionic form, less than 0.1 wt % of the polymer precipitates out.

The polymer should be stable and not degrade or decompose during the recovery or regeneration process. In this preferred embodiment, the draw solute polymer, in either its ionic or non-ionic state, is stable in aqueous solution up to 100° C., losing no more than of 0.0001 wt % under these conditions.

In a preferred embodiment of this invention where the draw solute is a polymer, the polymer is constructed from amine-based monomers, with the monomer having the base formula —[R1R2R3N]—, where R1, R2, and R3 are as described previously. In a more preferred embodiment, the monomer amine is a tertiary amine (where none of R1, R2, and R3 is a hydrogen atom). In another embodiment, the polymer may be a co-polymer, where two or more different monomers form the polymer chain, with at least one of the monomers being amine-based as described above. In yet another embodiment, the draw solute is a mixture of two or more polymers with an amine-based monomer.

### Ionizing Agent

In the embodiment of this invention, the ionizing agent is a material when in solution with water, can generate a proton which is then subsequently used to create the cation of the draw solute. In the preferred embodiment of this invention, the ionizing agent is a chemical in the gas phase at standard ambient conditions (25° C., 1 atm) that has a low solubility in pure water, less than 0.1 g/ml, or a Henry's constant of 1×104 (Pa/mol-fraction) or greater. More preferably, this material is CO2, CS2, COS, NO2, or SO2, or a mixture of 2 or more of these gases. Most preferably, the ionizing agent is CO2. In another embodiment, the ionizing agent is a Brönsted acid. In a preferred embodied, the Brönsted acid is hydrochloric acid, carbonic acid, formic acid, nitric acid, or a combination of two or more of these.

### Draw Solution Composition and Properties

In the embodiment of this invention, the draw solute and the ionizing agent must react in water to produce an ionic form to increase the osmotic pressure of the draw solution. In the preferred embodiment, the reaction between the draw solute and ionizing agent to form the ionic form must be spontaneous at temperatures less than 90° C. at 1 atm, and more preferably at temperatures less than 50° C. at 1 atm, and most preferably, at temperatures less than 35° C. at 1 atm.

To switch the draw solute, there must be at least one molecule of ionizing agent for each amine-like nitrogen atom in the draw solute molecule. The amine-like center is where either Equation (1) or (2) will occur. For the preferred gas phase and liquid phase tertiary amine draw solutes, there is expected to be one amine-like nitrogen atom for each draw solute molecule to react with one molecule of the ionizing agent, as demonstrated by Equation (1). For the polymer draw solute, there would be many amine-like nitrogen atoms on the polymer chain molecule. The molar ratio of ionizing agent to amine-like nitrogen centers in the draw solute, defined here as the ionizing agent-to-amine molar ratio, must be at least 1 to fully switch the draw solute to its ionic state, assuming ideal conversion to the bicarbonate salt form. In the embodiment of this invention, the ionizing agent-to-amine molar ratio is in the range from 1 to 10. In a more preferred embodiment of this invention, the ionizing agent-to-amine molar ratio is in the range from 1 to 2, and in the most preferred embodiment, at a ratio from 1 to 1.5.

As described, the draw solute and the ionizing agent are both present in the concentrated draw solution prior to the membrane process. In the embodiment of this invention, the concentration of the concentrated draw solution, containing both the switchable draw solute and ionizing agent, is between 5 wt % to 90 wt %. In a more preferred embodiment, the draw solution concentration is between 25 wt % and 80 wt %.

For the FO sub-system in this invention, the draw solution is prepared in its concentrated form from the draw solute and ionizing agent prior to the membrane. In the embodiment of this invention, the concentrated draw solution has an osmotic pressure of 100 atm or greater. In the more preferred embodiment, the concentrated draw solution has an osmotic pressure of 200 atm or greater. In the most preferred embodiment, the concentrated draw solution has an osmotic pressure of 400 atm or greater. For the draw solutions as embodied by this invention, these osmotic pressures will generally occur in solutions of 25 wt % or greater concentration of the switchable draw solute.

The concentrated draw solution passes through the draw side of the membrane against a feed solution with lower osmotic pressure. The resulting osmotic pressure differential causes water to be drawn from the feed solution through the membrane into the draw solution, making it more dilute. In the embodiment of this invention, the flow rates of the feed solution and draw solution are adjusted based on the membrane size and operating characteristics as to have the draw solution be diluted from between 25% and 90% of its original concentration of switchable draw solute. In a more preferred embodiment, the dilution of the draw solution by water is between 40% and 60% from its concentrated form.

In the embodiment of this invention, the draw solute and ionizing agent are recovered from the diluted draw solution by applying a driving force, such as heat or energy, pressure via a vacuum, agitation, gas sparging, or phase equilibrium, to dissociate of the draw solute via the thermolytic reaction. The draw solute and ionizing agent are dissociated, with the draw solute reverting to its non-ionized form. In the preferred embodiment of this invention, the reaction to revert the ionized draw solute to its non-ionized form occurs at a temperature less than 90° C. at 1 atm, and more preferable at temperatures less than 75° C. at 1 atm and most preferably at temperatures less than 60° C. at 1 atm.

Further, in the embodiment of this invention, the clean water is produced by removing the non-ionized draw solute and the ionizing agent from the draw solution. This mode is more desirable than producing water by separating the water from the draw solution through evaporation or vaporization. Evaporation and vaporization have high energy costs associated with the phase change of water. In the preferred embodiment, the non-ionic draw solute and the ionizing agent removal from water should occur at temperatures less than 90° C. at 1 atm; more preferably at temperatures less than 75° C. at 1 atm, and most preferably at temperatures less than 60° C. at 1 atm. Most preferably, the processes to remove the non-ionic draw solute and the ionizing agent from water should be thermodynamic favored at standard ambient conditions, with the Gibbs free energy change of the removal reaction being a net negative value.

### Membrane

In the embodiment of this invention, the membrane process of the FO water treatment sub-system uses at least one membrane unit that houses a semi-permeable membrane which is designed to allow water to pass through the membrane while restricting the flow of other contaminants in the water, including anions and cations, suspended solids, organic molecules, and biological materials. As previously described, multiple membrane units with their own semi-permeable membrane may be used.

Typical membranes identified for osmotic processes (both RO and FO) are supported membranes containing one or more thin active layers where the primary reject of water contaminants occurs, and a more porous support layer that provides structural stability against hydrodynamic stresses. Additional active layers can increase salt rejection and reduce reverse salt flux. In a preferred embodiment of this invention, the membrane used in the membrane unit is a single-active layer supported membrane. In another preferred embodiment, the membrane is a double- or triple-active layer supported membrane.

The orientation of the active layer relative to the draw solution can affect the membrane performance, as this will create internal concentration polarization (ICP) within the membrane itself In most cases, membranes with active layers used for FO applications are used in “FO mode”, with the active layer against the feed solution and the support layer towards the draw solution. In some cases, the membrane may be used in “PRO mode” (Pressure retarded osmosis), with the active layer against the draw solution. FO performance in PRO mode is typically less than that in FO mode as PRO mode will develop large ICP effects that reduce the effective driving force for osmotic draw. In the preferred embodiment of this invention when supported membranes are used, the membrane is oriented in FO mode relative to the feed and draw solutions. In another embodiment, the supported membrane is oriented in PRO mode.

In another embodiment of this invention, the membrane is a symmetric or asymmetric self-supporting membrane, consisting of one single layer. The mechanical strength of the semi-porous material is sufficient to withstand hydrodynamic stresses. A symmetric self-supporting membrane will have approximately the same porosity, tortuosity, and other structural factors throughout its thickness, so that that the osmotic performance will not be affected by which direction it is placed between the feed and draw solutions. An asymmetric self-supporting membrane will have an engineered variation in the membrane structural factors through its thickness, such as smaller pore openings towards one side of the membrane, and its orientation will affect its performance as in the case of a supported membrane. Single layer membranes can reduce the impact of the ICP on the water flux.

In yet another embodiment of this invention, the membrane has active layers on both sides of the support layer, also known as double-skin membranes. The addition of the second active layer can reduce the effect of the ICP, and can also eliminate some of the reverse salt flux that can occur in FO membranes. In a preferred embodiment of this invention, the two active layers are composed of different materials. This allows the active layer to be tuned to both the feed solution and the draw solution separately.

In preferred embodiment of this invention, the FO membrane is constructed of inorganic materials. Draw solutions using switchable draw solutes will generally be highly caustic, with pH ranging from 7 to 13 and higher. Many organic materials used for membranes can tolerate a pH up to 9 or 10 but not higher. Cellulose triacetate (CTA), a common inexpensive membrane based on naturally-derived cellulosic material, can only sustain a pH range from 4 to 8, and would quickly degrade in most draw solutions using switchable draw solutes. Inorganic membranes will typically have a much wider pH tolerance range, and would not degrade in caustic conditions. Further, the presence of the ICP within the membrane will serve to concentrate the caustic solute within the membrane and will exacerbate degradation of the membrane materials. It is thus necessary to use membrane materials that can withstand the higher localized pH created by the ICP.

Some examples of preferred membranes that are embodied by this invention include but not limited to:

Ceramic materials based on alumina, silica, zirconia, and other materials and mixtures thereof. Ceramics are very durable materials. These materials can be prepared through sol-gels to obtain a nano-porous structure to meet water flux and salt rejection requirements.

Borosilicate glass membranes, which possess higher structural stability and lower thermal expansion than typical glasses, and can be constructed to provide porosity necessary for water permeability and salt rejection.

Zeolite-based membranes typically based on frameworks of alumina and silica but may include other metal-oxide components, as well as zeolites that are loaded and functionalized by metal and metal oxide. The narrow pore structures of some zeolite structures can reject salt while allowing for water flow.

Carbon-only based structures such as carbon nanotubes and graphene. These materials are generally stable in a wide range of pH values due to the stability of the carbon-carbon bond structures. These materials also have a natural hydrophobicity that enhances the flow of water through the narrow structures.

Another embodiment of this invention is the use of mixed-phased inorganic-organic membranes as supported single or double-skin membranes. These materials would have an inorganic layer (such as the materials identified above) atop a water-permeable organic membrane. In the membrane units, the caustic-tolerant inorganic layer would be exposed to the draw solution, while the less-tolerant organic side exposed to the feed solution. The combination of materials would provide good permeability characteristics of organic membranes, and the required durability towards the caustic draw solution from the inorganic material. In this embodiment, the inorganic component of the membrane would be of those classes identified above. The organic substrate of the membrane would be a material known for good water permeability, and can include but is not limited to polymers such as polyamides, polysulfates, Teflon, and cellulose triacetate.

The geometry and form factor of the membrane unit will be a function of the underlying material and design of the membrane modules. In the embodiment of this invention, the membrane may be constructed as a tubular membrane, hollow fiber membrane, a flat sheet membrane, spiral wound membrane, or a plate-and-frame membrane.

### Membrane Cascade

There is presently little data that demonstrates the performance and durability of membranes in use with switchable FO draw solutions. As described above, current RO membranes have drawbacks that impact FO systems, and commercially available RO membranes have compatibility issues with the caustic switchable FO solutions. There are current efforts to engineer better FO membranes but it is unclear what will be the best solution for switchable FO systems at the present time. To address this unknown, the embodiment of this invention features a membrane cascade that is composed of a combination of series or parallel membrane configurations. This cascade can be used to select membranes with various durability and performance and utilize these in the most optimal manner, maximizing water draw and minimizing salt flux and membrane degradation within the switchable FO water treatment sub-system.

In the embodiment of this invention, the membrane process of the FO water treatment sub-system includes at least one membrane unit. A single membrane unit has a maximum effective capacity for water draw resulting from membrane and geometry limitations, so multiple membranes are required to scale the water treatment process to larger volumes.

In a preferred embodiment of this invention, the membrane process contains two or more membranes units arranged in a series configuration, where the concentrated feed water outlet from one membrane serves as the diluted feed water inlet on a different membrane. Many membranes can be arranged in series on this flow configuration. In one preferred embodiment, the draw solution may also be similarly arranged in flow series, with the diluted draw solution outlet from one membrane serving as the concentrated draw solution for a second membrane, and continuing for all other membranes before returning to the recovery process. In this embodiment, the flow of draw solution may be counter-current or co-current with respect to the feed water flow. In another preferred embodiment, the draw solution may be split individually between each of the modules, passing through some of the membrane units before being returned to the recovery process. In yet another preferred embodiment, the draw solution is split among some of the membranes in series to achieve a combination of the prior two embodiments. For example, if there are four membranes in series, the draw solution may be split to feed the first and third membranes; the diluted draw solution from the first membrane serves the second membrane, and the diluted draw solution from the first membrane serves the fourth membrane. In a preferred embodiment for membranes in series, upstream and downstream valves and plumbing are included to allow feed and draw flow to bypass a given module in the series.

In another preferred embodiment of this invention, the membrane process contains two or more membranes arranged in a parallel configuration. In the preferred embodiment, the membrane units are of equivalent design and performance specifications. In this configuration, both the feed and draw solutions are equivalently split between each membrane in the parallel configuration. In a preferred embodiment, valves are included in both upstream and downstream paths of the feed and draw solution on each membrane to isolate that membrane from the others in the parallel configuration.

In yet another preferred embodiment of this invention, the membrane process contains three or more membranes arranged in a combination of the series and parallel configurations described above. For example, the membrane process could consist of 4 parallel banks, each with 2 membrane units in series, for a total of eight membrane units. Many such configurations could exist, and this invention documents only some of these possible configurations.

In these embodiments where multiple membranes are used in the membrane process, the membranes do not have to be of the same material type, configuration or operating conditions. This enables the use of different membrane materials to optimize the forward osmosis process while recognizing that there may be material incompatibility between the concentrated draw solution and membrane materials. This optimizes the membrane system for maximum water recovery by discretizing the membrane process over multiple membranes, using each membrane type for its best use and within its durability and other performance characteristic levels. For example, in the series configuration, the first membrane that the concentrated draw solution contacts may be of an inorganic material with high durability towards the caustic fluid, but with poor permeability, while subsequent membranes in the series configuration are of high permeability but are only durable with diluted draw solution. The first membrane is thus configured to draw enough water from the feed into the draw to dilute the draw solution, reduce its pH, and making the effluent draw solution compatible with the remaining membranes. This concepts works in conjunction with monitoring the performance across each membrane within the control system of the FO water treatment sub-system, as described below

The exact configuration and types of membranes would be a function of the draw solution, feed solution, and water quality requirements. The exact configuration would need to be optimized based on membrane performance, capital and operational costs, and other process efficiencies and economics. These concepts are discussed in Example 2 below.

### Recovery Process

Following the membrane, the diluted draw solution must be processed to separate the switchable draw solute and the ionizing agent from the water. In the embodiment of this invention, this requires the dissociation of the ionizing agent from the switchable draw solute, leaving the solute in its non-ionic, insoluble form, and either the simultaneous or subsequent removal of the insoluble switchable draw solute from water. This may be performed in a single processing step or over multiple processing steps depending on the nature of the switchable draw solute.

Complete (100%) removal of the draw solute and ionizing agent from the draw solution within the recovery process possible but generally not practical. The recovery processes are based on phase and chemical equilibrium processes. Complete removal may not be possible due to azeotropes or it may require a great deal of energy and residence time. The more complete of draw solute separation from the water, the easier it is for the FO water treatment subsystem to produce clean water. In the preferred embodiment of this invention, at least 75% of the ionizing agent and draw solute are removed from the processed dilute draw solution in the recovery process. In a more preferred embodiment, at least 95% of the ionizing agent and draw solute are removed from the processed draw solution in the recovery process. In the most preferred embodiment, at least 99% of the ionizing agent and draw solute are removed from the processed draw solution in the recovery process.

One means of improving the extraction of draw solute and ionizing agent from the diluted draw solution is to operate the recovery process on a portion of draw solution. It is not required to fully separate the draw solute from the water since the regeneration process will ultimately recombine these in the concentrated draw solution. This serves to lower the energy requirements for the recovery process. In a preferred embodiment of this invention, the diluted draw solution is split; some fraction of the diluted draw solution is processed to separate the ionizing agent and the switchable draw solute material, while the remaining draw solution material bypasses the recovery process and goes directly to the regeneration process as a bypass stream. In a more preferred embodiment, this split fraction will be determined based on the design of water draw within the membrane process so that the amount of water in the diluted draw solution to be processed in the removal stage will be within 10% of the amount of water drawn across the membrane. In this situation, the re-addition of the recovered switchable draw solute and ionizing agent to the remaining diluted draw stream will bring the stream back up to the target concentration for the draw solution, eliminating the need for additional water. For example, if the draw solution flowing at 100 gal/hr is designed to draw 50 gal/hr of water across the membrane process to generate 150 gal/hr of diluted draw solution, then only 33%+/−10% of the diluted draw solution (representing 50+/−5 gal/hr) will be split into the recovery process, the remaining solution sent to the regeneration system.

In the embodiment of this invention, the dissociation of the ionizing agent is an endothermic reaction, requiring the input of energy into the process. In the embodiment of this patent, the energy comes from a thermal source, which can include but not limited to generated heat from electrical or chemical sources, heat integration with other processes within the forward osmosis sub-system, heat integration with other sub-systems of the water treatment system, heat integration from external sources from the water treatment system such as flue gases from a combustion source, or any combination of two or more of these sources. In this embodiment of this invention, the process unit where heat is used to remove the ionizing agent includes but is not limited to: a closed tank, a mixing tank, a packed column, a tray column, a distillation tower, or two or more of these units used in series or parallel configurations.

Operating a vacuum can lower the temperature in which the ionizing agent can be easily separated from the water. In the preferred embodiment of this invention, the process to remove the ionizing agent with heat is performed under a vacuum from 0.1 to 1 atm. In the more preferred embodiment, the process is performed under a vacuum from 0.5 to 1 atm. In a preferred embodiment where a vacuum is employed, the vacuum can be generated using a vacuum pump downstream of the recovery unit with respect to the recovered gas stream. In a more preferred embodiment the vacuum is created from a venturi-type pump or an ejector located on the flow of draw solution or water prior to the regeneration system. The Venturi effect on the liquid flow draws the gas phase from the recovery process into the liquid flow where it will be regenerated.

In a further preferred embodiment, when a vacuum is applied to the recovery process for either the liquid phase or polymer solute, a chiller or condenser is incorporated on the vacuum line. This chiller or condenser can capture the water that is inevitably vaporized by the recovery process due to its vapor pressure at elevated temperatures, and travels with the ionizing agent to the regeneration process. The condensed water from this process unit will be of very high quality though of low volume, but represents another effluent from the forward osmosis sub-system.

Another means to improve the separation of the ionizing agent from the water is by sparging or bubbling an inert gas through the diluted draw solution. The gas can alter the vapor-liquid equilibrium of the separation process, driving more of the ionizing agent out of the diluted draw solution. As this is a mass-transfer limited process, the bubbles should be well-agitated and as small as possible to provide a large amount of interfacial surface area. Gas sparging with microbubbles (<100 um) or nanobubbles (<1 um) are known to enhance mass-transfer limited reaction rates in other processes. In another preferred embodiment of this invention, the process to remove the ionizing agent is through the use of gas bubbling with a gas that has less than 1% of the ionizing agent and draw solute. In a more preferred embodiment, this gas is an inert gas which includes but is not limited to nitrogen, oxygen, air, or steam. In a different preferred version, the process to remove the ionizing agent is through the use of gas bubbling with CO2 or a gas mixture with more than 1% CO2.

In the preferred embodiment where gas sparging or bubbling is used in the recovery process, the gas is introduced through a device within the separation unit that produces bubbles within the diluted draw solution, which can include but not limited to fits, screens, semi-permeable membranes, and gas spargers. In a more preferred embodiment, the bubbles generated by this device are less than 100 um in size. In an even more preferred embodiment, the bubbles generated by this device are less than 1 um in size.

### Specific Recovery Processes Based on Draw Solute Phase

When the draw solute is nominally a gas at standard ambient conditions, only a single recovery step is required, as the draw solute and ionizing agent can be dissociated from each other and removed from the draw solution with the same process operation. In the preferred embodiment where the switchable draw solute is a gas, the process to remove the switchable draw solute and the ionizing agent includes but is not limited to: a closed tank, a mixing tank, a packed column, a tray column, a stripping tower, a distillation tower, membrane distillation or two or more of these units used in series or parallel configurations. The resulting gas stream, rich in both the switchable agent and ionizing agent, is sent to the regeneration unit.

When the draw solute is nominally a liquid at standard ambient conditions, two recovery steps are required. The first step is the dissociation of the ionizing agent from the draw solute and the removal of the ionizing agent from the draw solution. The remaining draw solution will be composed of the immiscible liquid phase and a water phase. The second step then is to separate the two immiscible phases. In this preferred embodiment, the process to remove the ionizing agent from the draw solution containing a liquid draw solute includes but is not limited to: a closed tank, a mixing tank, a packed column, a tray column, a distillation tower, membrane distillation or two or more of these units used in series or parallel configurations. In this preferred embodiment, the means to separate the phases includes but is not limited to: decanting, gravity-driven separation tank, centrifuge or a combination of two or more of the above systems in series or parallel configurations.

When the draw solute is a polymer, two recovery steps are required, similar to the liquid-based draw solute requirements. The first process step will dissociate the ionizing agent from the draw solute polymer, and then remove the ionizing agent. The non-ionic polymer will either remain suspended in solution or precipitate out within the produced water. As large non-ionic molecules, these polymers then can be easily separated from water through solid filtering processes. In this preferred embodiment, the process to remove the ionizing agent from the draw solution containing a polymer-based draw solute includes but is not limited to: a closed tank, a mixing tank, a packed column, a tray column, a distillation tower, membrane distillation or two or more of these units used in series or parallel configurations. In this preferred embodiment, the polymer is separated from the water using separation processes that include, but are not limited to, filters (including micro-filters and nano-filters), low-pressure reverse osmosis, decanters, gravity-driven separation tanks, centrifuges, or a combination of two or more of the above system in series or parallel configurations.

Regardless of the type of draw solute, the produced water following the switchable draw solute and ionizing agent dissociation and removal process may contain some of the draw solute material as well as any ions and salts that have crossed over the membrane. In this invention, a post-cleanup system is used to remove the switchable draw solute and other contaminants on the produced water downstream of the recovery process. The rejected portions of this water, which will include the switchable draw solute and other contaminants, are sent to the regeneration process of the forward osmosis sub-system. In this embodiment, the means of separation include, but are not limited to, a low-pressure reverse osmosis unit, a filtration unit including micro- and nano-filtration, or a combination of two or more of these units in series or parallel configurations.

### Regeneration System

The diluted draw solution is regenerated to its concentrated form, following the extraction of produced water in the recovery system. In this invention, the recovered stream(s) containing the switchable draw solute and the ionizing agent are mixed with water to produce the concentrated draw solution stream. In the preferred embodiment where only a portion of the diluted draw stream is processed for switchable draw solute recovery, this regeneration also mixes in the fraction of the diluted draw solution stream that was not processed for switchable draw solute recovery (the bypass stream).

This regeneration process is exothermic. In the embodiment of this invention, the heat generated by the exothermic regeneration is recovered to be used elsewhere within other parts of the overall systems, including but not limited to: within the forward osmosis sub-system, other sub-systems of the water treatment system, within other processes outside the water treatment system, or a combination of these locations. In the preferred embodiment of this invention, the heat generated by the draw solution regeneration is utilized within the draw solution recovery process. In an embodiment of the invention, heat is transferred through the use of a heat transfer material (like water or a coolant) from one process to another. In another embodiment of this invention, there is physical integration of the regeneration process and the recovery process for the direct utilization of the regeneration reaction heat

In the embodiment of this invention, the regeneration process can occur in a process vessel that includes but not limited to: a closed tank, a mixing tank, a packed column, a tray column, a distillation tower, or a combination of two or more of these units.

In some embodiments of this invention, the ionizing agent and possibly the switchable draw solute will be reintroduced into the draw solution as a gas. The regeneration process will be limited by mass-transfer between the gas and liquid phases, but can be enhanced by physical mixing and introducing the gas in small bubbles into the regenerated draw solution to increase the surface area for mass transfer. In a preferred embodiment of this invention, the gases are introduced through a device within the separation unit that produces bubbles within the regenerated draw solution, which can include but not limited to frits, screens, semi-permeable membranes, and gas spargers. In a more preferred embodiment, the bubbles generated by this device are less than 100 um in size. In an even more preferred embodiment, the bubbles generated by this device are less than 1 um in size.

### Makeup/Blowdown, Adjustable Concentration

The draw solution recycle loop (between the regeneration process, membrane process, and recovery process) will accumulate ions and salts that have crossed over the membrane, as well as any chemical components from possible side reactions of the switching mechanism of the switching draw solute and ionizing agent. In the embodiment of this invention, the draw solution recycle loop includes a blowdown port to exhaust a fraction of the draw solution, and one or more makeup sources to add in fresh draw solution. In a preferred embodiment, the makeup for the draw solution is provided as the concentrated form of the draw solution. The concentrated draw solution may not be able to be stored indefinitely. In another preferred embodiment, the makeup for the draw solution is provided from separate sources of draw solute, ionizing agent, and/or water.

The makeup and blowdown processes can be further used to adjust the concentration of the draw solution prior to the regeneration process by managing the addition of both draw solute and ionizing agent following blowdown. This can be used as part of the FO water treatment sub-system control system in response to internal or external controls. The concentration of the draw solution can be raised in response to an increase in the salinity of the incoming feed water. The concentrated draw solution will have a higher osmotic pressure to counter the increase in the feed water, and maintain the water draw across the FO membrane(s).

This change can be more desirable than changing other operating parameters such as flow rates. Membranes are typically designed to operate at a specific crossflow velocity (the rate of flow of feed and draw solutions parallel to the membrane surface), so changes in flow rate will affect these conditions. Further, with FO membranes, the ICP and ECP phenomena are strong functions of the flow rate of the fluids. Changes in the cross-flow velocity will impact the strength of these. Flow rates and other hydrodynamic factors can be kept near the design point while still achieving a high osmotic pressure differential to pull water across the membrane at the same rate by making small adjustments in the concentration of the draw solution

A further benefit of being able to change the switchable draw solution concentration is towards material compatibility with the membrane system. The switchable draw solution will be highly caustic and many commercial RO membranes cannot handle caustic solutions. The effects of ICP and ECP can create localized areas within the membrane where the pH is higher than that of the draw solution, potentially damaging the membrane. The membrane cascade system previously described can enable the use of low durability but high permeability membranes alongside more durable ones. It will be necessary to keep the pH of the draw solution within acceptable operating range for membranes with lower durability. In situations where the feed solution has a lower salinity than as designed, it can be advantageous to reduce the concentration of the draw solution to minimize the pH further below the membrane's tolerance levels to extend the lifetime of the membrane. The adjustment of the draw solution concentration can also help mitigate the impact on the system should a membrane within the cascade require premature maintenance or replacement, thus achieving a turn-down ratio of the output of each of the remaining membrane units. For example, if one membrane from a parallel bank of membranes must be isolated for maintenance or replacement, the water draw could be kept constant by increasing the draw solution concentration and the effective osmotic pressure differential across the remaining membranes as long as this does not impact their durability.

Both the draw solution concentration adjustment and the membrane cascade system enable the FO water treatment sub-system to operate at maximum clean water production while maintaining the durability of the membranes against highly fluctuating feed streams. The membrane discretization approach is a flexible design that can accommodate wide fluctuations in the feed water concentration while maintaining material durability with the caustic draw solution.

In a preferred embodiment of the makeup and blowdown process, the concentration of the draw solution is managed by metered addition of makeup from one or more sources of either various concentrations of the draw solution, the pure draw solute, the pure ionizing agent, distilled water, or other mixtures of the draw solute or ionizing agent in water. In another preferred embodiment, the concentration of the draw solution is adjusted by diverting a fraction of the flows from either the dilute draw solution that bypasses the recovery process, or the recovered draw solute and ionizing agent from the recovery process. For example, the concentration of the draw solution in the regeneration process can be increased by using only a portion of the bypass diluted draw solution in combination with the draw solute and ionizing agent recovery streams. Similarly, the concentration of the draw solution following regeneration can be reduced by using only a portion of the draw solute and ionizing agent recovery stream. The unused portion of either stream is sent as blowdown or recovered in a buffer tank to prepare through off-line means for reuse in the process. In yet another preferred embodiment, the concentration of the draw solution is adjusted by changing the operating parameters within the recovery or regeneration processes. These operating parameters include but are not limited to: operating temperature, operating pressure, or flow rates. These changes would need to be designed to avoid disrupting the rate of produced water from the switchable FO process.

### FO Process Integration

In the embodiment of this invention, the draw solution regeneration process, the membrane process, and the draw solution recovery process are considered as separate unit operations or components within the water treatment sub-system. In a preferred embodiment of this invention, the regeneration and the recovery processes are physically integrated as to directly route the heat created by the regeneration process into the recovery process. Such integration may include specialized vessels with separate chambers for regeneration and recovery, designed to allow heat to pass from one chamber to the other, or may include routing the diluted draw solution stream or the stream used for gas stripping through a jacket of the regeneration system, as to provide this heat just prior to the recovery vessel.

In another embodiment, the membrane process and the recovery process are integrated into the same physical unit. In one preferred embodiment, the recovery process will be based on membrane distillation (MD) techniques, with the overall physical unit being a hybrid FO/membrane distillation process. Prior to the membrane, the concentrated draw solution is heated to a temperature of at least 30° C. but less than 90° C. The higher temperature improves the draw of water across the FO membrane, and also enables the MD process. There are two methods which the MD process can be operated. In a more preferred embodiment, the MD membrane is hydrophobic, and the MD process removes the ionizing agent and possibly gaseous switchable draw solute from the draw solution, leaving clean water. In another more preferred embodiment, the MD membrane is hydrophilic, and the MD process pulls water out of the draw solution. In the preferred embodiment using the MD process embodiment, the material that passes through the MD membrane is recovered through either direct contact with a permeate fluid, air gap condensation, vacuum draw, or sweeping gas.

In another preferred embodiment of membrane and recovery integration, the recovery process will be based on membrane filtration techniques, creating a hybrid FO-filtration physical unit. Prior to this unit, the diluted draw solution would be pressurized. The pressure will be a function of the pore size of the filtration membrane. Filtration with smaller pores will require higher pressures. The higher pressure of the draw solution will work against the osmotic driving force across the forward osmosis membrane, so high hydraulic pressures are undesirable. With the draw solution pressurized, water will be pushed through the filtration membrane while large molecules will be unable to pass through. The resulting water passing through the filtration membrane will be clean water.

In the preferred embodiment of this invention where this hybrid FO-membrane filtration unit is used, the filtration membrane has an average pore size that is less than the average molecule size of the switchable draw solute. In a more preferred embodiment, this hybrid FO-membrane filtration unit is used when the draw solute has a molecular size greater than 150 nm, and the filtration membrane is a micro-filtration membrane with pore sizes no greater than 100 nm. The solute would not pass through the membrane in this configuration, and only 2-4 atm of hydraulic pressure would be needed to push water through the membrane, which would not significantly impact the FO process. This hybrid FO-membrane filtration unit is best suited for the polymer-based switchable draw solution due the large size of the macro-molecules, but may also be used when the draw solute is a one of the gas or liquid-base solutes with a large molecular weight and molecule size.

### Controls System

In the embodiment of this invention, the forward osmosis water treatment sub-system is monitored through the use of sensors on the feed water, the draw solution loop, and the produced water by a control system which records all collected data. In the embodiment of this invention, the sensed data can include but are not limited to: temperature, pressure, density, flow rate, pH, conductivity, viscosity, chemical/compositional analysis, turbidity, discoloration, total dissolved and suspended solids, and biological and chemical oxygen demand. Several of these types of measurements can be directly related to the quality of the water or draw solution, which will impact the performance of the membrane, the recovery process, and the regeneration processes. In a preferred embodiment of this system, the forward osmosis water treatment sub-system control system obtains and records sensor data from other locations outside of the forward osmosis sub-system, such as but not limited to: upstream feed water quality, sensors on upstream water treatment sub-systems, ambient temperature and pressure, weather conditions, and downstream water quality.

In a preferred embodiment of this invention, the control system on the FO water treatment sub-system is used to automatically manage control hardware within the forward osmosis process based on the input from the sub-system's sensors and external information, and records all actions taken. In this preferred embodiment, the control system manages a variety of hardware including but not limited to: hydraulic and vacuum pumps, valves, pressure regulators, heaters, chillers, temperature regulators, and to interface and support operator and process safety. In a more preferred embodiment of this invention, the control system is used to adjust the flow rate and concentration of the regenerated draw solution to track against internal changes of the draw solution composition, or to changes in the quality of the feed water. For example, the control system can react to a temporary increase in the concentration of contaminants in the upstream feed water by increasing the concentration of the switchable draw solution. The concentration of the draw solution in this embodiment can be managed through a combination of controllers, including the fraction of diluted draw solution used in the recovery process, and through the makeup and blowdown process, as previously described in the makeup/blowdown embodiment of this invention. In a preferred embodiment, the FO water treatment control system also includes means for manual interaction from human operators, including initiating safety and failsafe processes (HAZOPS).

In another preferred embodiment, the sensors and control system are used in combination with the membrane system to track the performance and quality of the membranes. Measurements relating to pressure can immediately indicate membrane failures such as breakthrough, while fouling of the membrane can be determined based on declination of the water flux across the membrane and the degree of dilution of the draw solution.

In another more preferred embodiment, in which multiple membrane units are configured in parallel, sensors are placed around each individual membrane unit. The control system can determine which membrane is failing and isolate it, using valves on the membrane process as previously described, while allowing the other membranes to continue to operate. In an even more preferred embodiment, the control system can initiate an automatic flushing or washing of the isolated membranes to remove fouling.

In another more preferred embodiment, in which multiple membranes are configured in serial, the control system can enable or bypass individual membrane elements in response to changes in the system. This type of response may be preferred when individual membrane elements are not be highly durable but effective for short-term use. For example, if the control system detects an increase in the contamination of the feed water, the control system can enable flow through an additional membrane to handle the increased concentration, and then later bypass this membrane when the contamination returns to nominal levels.

In a preferred embodiment, the control system is used to monitor the state of the draw solution through the recycle loop (the regeneration process, the membrane process, and the recovery process), and alter the draw solution recovery, regeneration, and make up processes to maintain the concentration of the draw solution at the design or control points in response to monitored changes upstream of the FO sub-system. Such changes can include: adjustment of the draw solution concentration, changes in the temperature used for the recovery process, changes in the vacuum pressure used for the recovery process, enabling or disabling one or more membranes in the membrane system through valve controls, and changes in draw solution flow rate.

In the embodiment of this invention, the control system for the forward osmosis sub-system sends sensor data and control operations to the control system on the overall water treatment system. In the preferred embodiment, the control system on the overall water treatment system also communicates information and control logic to the control system of the forward osmosis sub-system.

### Overall System

In the embodiment of this invention, the water treatment system includes one or more water treatment sub-systems, with at least one of these sub-systems being a switchable FO sub-system as described above. Other sub-systems that may be present in the water stream system include but are not limited to: additional switchable FO sub-systems; non-switchable FO sub-systems; RO sub-systems; filtration sub-systems (including particulate filtration, microfiltration, ultrafiltration, and nanofiltration); evaporative and distillation sub-systems, membrane distillation and hybrid membrane sub-systems; chemical treatment, capture, and destruction sub-systems; ion exchange sub-systems; biological treatment and destruction sub-systems; ultra-violet (UV) treatment sub-systems; advanced oxidation treatment systems; settling tank sub-systems; and anti-scaling sub-systems.

In a preferred embodiment of the overall water treatment system, the sub-systems, including the FO water treatment sub-system, are arranged in series. In a more preferred embodiment, valves and plumbing are included around one or more sub-systems to enable the bypass of that sub-system.

In another preferred embodiment of the overall water treatment system, the sub-systems, including the FO water treatment sub-system, are arranged in parallel. In a more preferred embodiment, parallel sub-systems may be of the same sub-system type. This provides a system for handling high capacity water flows in a similar manner to the use of parallel membranes in the membrane system. In another preferred embodiment, parallel sub-systems may also be of different sub-system types, with a controls and monitoring system used to manage the amount of water each branch of the parallel configuration processes. In a preferred embodiment, valves and plumbing are located around one or more sub-systems as to be able to isolate that sub-system from others in the parallel arrangement.

In yet another preferred embodiment of the overall water treatment system, the sub-systems, including the FO water treatment sub-system, are arranged in a combination of series and parallel configurations. This configurable arrangement is designed to meet the water purification requirements. In a preferred embodiment, the switchable FO sub-system is the primary water treatment sub-system in the system. Additional water treatment sub-systems may be located up- or downstream of the switchable FO sub-system. Switchable FO systems have the potential to be a replacement for many large-scale systems, as well as to augment other water treatment systems. In a preferred embodiment, the switchable FO sub-system is located upstream or downstream from at least one additional primary water treatment sub-system. This primary water treatment sub-system may include, but is not limited to, a RO sub-system, a filtration sub-system, or an evaporation/distillation sub-system. Downstream sub-systems of the switchable FO sub-system may include but are not limited to RO sub-systems, FO sub-systems, UV sub-systems and chemical treatment systems. In an example of such a configuration, the switchable FO water treatment sub-system may operate on the concentrated reject from a different process, such as RO desalination. The higher osmotic pressure differential provided by the switchable draw solution can be used to extract more water from the reject, increasing the water recovery of the overall system.

In the embodiment of this invention, the overall water treatment system includes an automated monitoring and control system, which consists of a plurality of sensors and control units located between and within individual water treatment sub-systems on the system, all in communication with a central processing unit. The control system can also include self-contained control systems that are part of the individual water treatment sub-systems which also communicate with the central processing unit. The sensors will measure and record the quality and state of the water, which include but are not limited to: temperature, pressure, density, flow rate, pH, conductivity, viscosity, chemical/compositional analysis, turbidity, discoloration, total dissolved and suspended solids, and biological and chemical oxygen demand. Additional sensors for detection of external conditions can also be used; these sensors include but are not limited to measuring: ambient temperature and pressure, and storage tank levels. In a more preferred embodiment, the overall control system monitors for potential security threats to the systems and interfaces to supervisory control and data acquisition (SCADA). In this embodiment, the overall water treatment control system operates and records control unit hardware around the individual sub-systems. Control unit hardware can include, but are not limited to valves, pumps, pressure regulators, electric power generators, heaters, coolers, chillers, and to interface and support operator and process safety. In the preferred embodiment, the control system also includes means for manual interaction from human operators, including initiating safety and failsafe processes (HAZOPS). In the preferred embodiment, the overall control system, including the individual control systems on each sub-system, can be monitored and controlled remotely. In a more preferred embodiment, the overall control system remotely interfaces with sustainable platforms that aggregate data from relevant power grid operational systems, power producing facilities, water utility systems, water treatment facilities, and other power and water sources that support analytic and business intelligence capabilities for emissions and water trading.

In the embodiment of this invention, the control system incorporates data from several locations relative to the water treatment system, and operates the control units on the system to produce water of required quantity and quality. In this embodiment, locations for sensor data include but are not limited to: upstream feed water quality sensors, intra-process sensors between the sub-systems of the water treatment system, process sensors within each of the water treatment system's sub-systems in the water treatment system, and downstream water quality sensors. In a more preferred embodiment, the data may come from sources external to the water treatment system, including but not limited to: upstream water treatment plant data, produced water quality, ambient temperature and pressure, current weather conditions, time of day, current and projected produced water use, and peak utility hours.

In the preferred embodiment, the overall control system communicates changes in upstream water quality to the control system of the switchable FO sub-system as to maintain the desired performance of the FO sub-system and the overall water treatment system. These changes can be determined through monitoring all internal and external data sources. For example, if secondary or tertiary wastewater is used as a feed to the overall water treatment system, the overall control system may sense a change in conditions at the wastewater treatment facility, such as an increase in salinity of the wastewater, and communicates to the FO sub-system to adjust its draw solvent concentration to manage the incoming water.

### DETAILED DESCRIPTION OF DRAWINGS

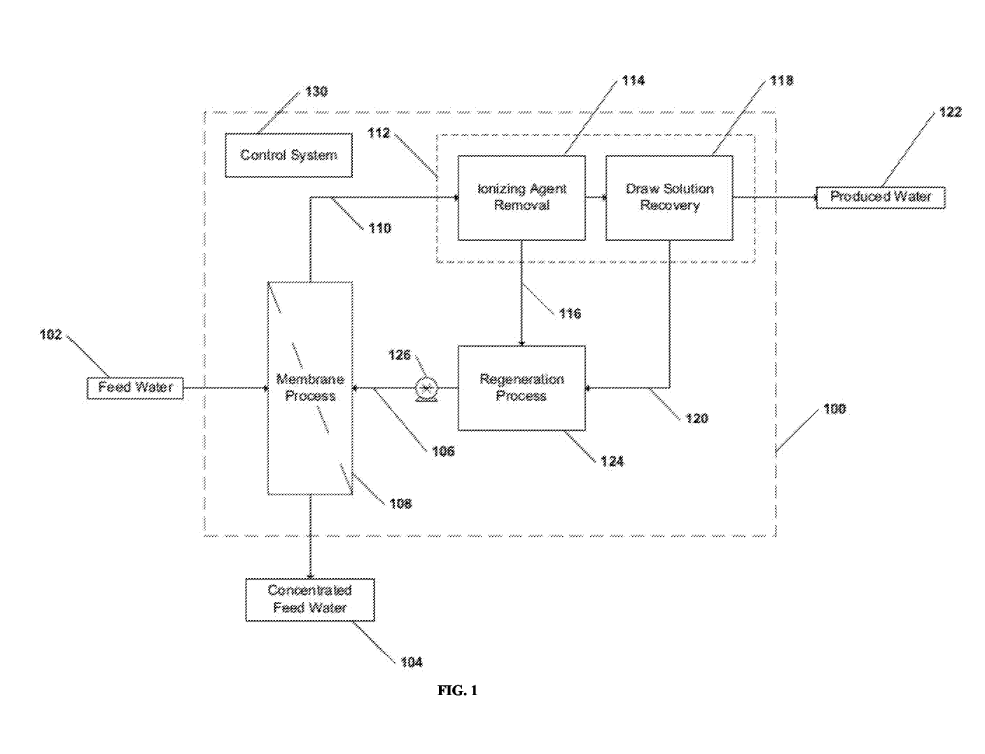

A single FO water treatment sub-system 100 is shown in FIG. 1. Feed water 102 either directly from a source or from an upstream water treatment sub-system is sent through the membrane process 108, which will draw water from the feed water into the draw solution 106. The remaining concentrated feed water 104 leaves the membrane to be processed by downstream water treatment sources, send to an appropriate receiving draining sink or sewage, or captured for removal and disposal.

The concentrated draw solution 106 enters the membrane 108, accumulated water drawn from the feed water due to forward osmosis, and leaves as a diluted draw solution stream 110. A recovery system 112 consists of two processes which may or may not occur within the same process unit: the removal of the ionizing agent 114 and the recovery of the switchable draw solute 118. These two processes generate the gaseous ionizing agent stream 116 and the switchable draw solute 120. The concentrated draw solution 106 is restored through a regeneration process 124 which combines the recovered ionizing agent stream 116 and switchable draw solute stream 120. A pump 126 is used to send the regenerated concentrated draw solution into the membrane 108, completing the loop. The produced water 122 from the recovery processes 112 is either sent to downstream water treatment processes for additional treatment, or sent to the water's point of use. A control system 130 monitors and controls the operation of the forward osmosis water treatment sub-system.

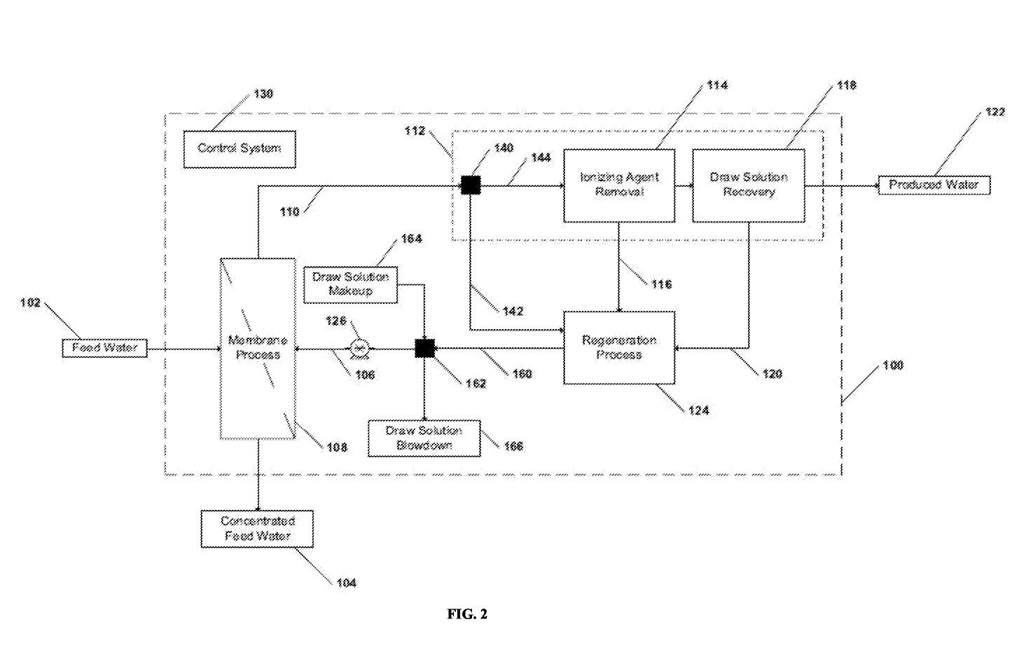

Referring now to FIG. 2, the recovery process 112 includes the embodiment of where the diluted draw solution 110 is split using a flow control device 140. Some of the diluted draw solution is diverted from the ionizing agent removal process 114 and draw solution recovery process 118 and instead sent to the regeneration process 124 through a bypass line 142. The remainder of the diluted draw stream 144 continues to these recovery processes. The fraction of the total diluted draw solution stream 110 that is sent to bypass stream 142 will be based on the design parameters of the membrane system 108 and the target produced water 122 rate. For example, if the net flow of concentrated solution 106 is 100 gal/hr, and a total of 50 gal/hr of water is drawn across the membrane system 108 under the given design conditions, the total diluted draw stream 110 will be 150 gal/hr. In this configuration, approximately 66% of the dilute draw stream 110 can be diverted to bypass stream 142, the remaining diluted draw solution being processed to recover 50 gal/hr of produced water 122. The exact ratio will be a function of the efficiencies of the ionizing agent removal process 114 and draw solution recovery process 118.

The draw solution loop will accumulate salts, ions, and other contaminants that will invariably cross over the membrane 108, requiring some manner to remove these species. The recovery processes 112 may also generate undesired species from side reactions that will reduce the effectiveness of the draw solution. FIG. 2 includes the embodiment of this invention in which this accumulation can be removed from the draw solution loop under continuous operation through blowdown. The regenerated concentrated draw solution 160 is processed by a makeup and blowdown process 162. A portion of the existing draw solution, which includes the contaminants that have crossed over the membrane system 108 is let out and collected as blowdown 166. The draw solution is immediately made up using an equivalent volume of premade concentrated draw solution 164 free of contaminants. This configuration assumes that the draw solution can be stored safely and in a stable concentrated state. This may not be possible for some of the switchable draw solutes described within this invention due to chemical compatibility with storage materials, or if the switchable draw solute will revert from its ionic to non-ionic state over time.

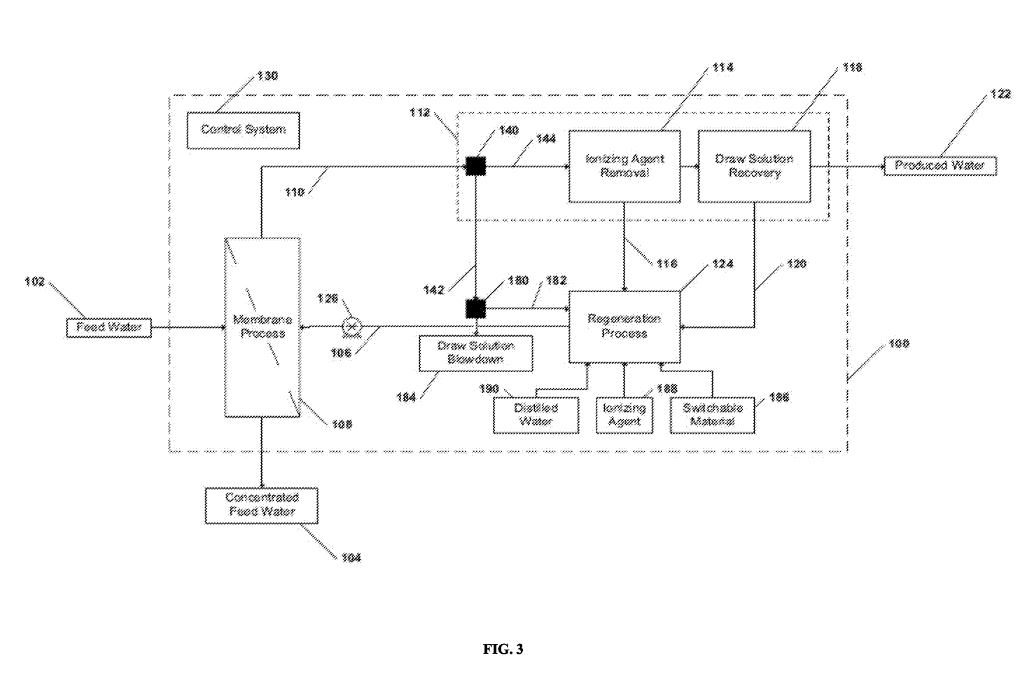

Now referring to FIG. 3, this configuration demonstrates the same blowdown and makeup system where it may not be possible to store the concentrated make up draw solution indefinitely. In this embodiment, the blowdown of the diluted draw solution 184 would be done upstream of the regeneration process 124 off the bypass stream 142. The remaining bypass stream 182, the recovered ionizing agent 118 and switchable draw solute 120 enter the regeneration process 124. The makeup of draw solution is done by adding the appropriate ratio of switchable draw solute 186, ionizing agent 188, and water 190 into the regeneration process. Because the regeneration of the draw solution from the switchable draw solute and ionizing agent is an exothermic process, preparing the makeup within the regeneration process 124 allows that heat to be recovered in addition to the heat generated by the regeneration of the ionizing agent 116 and switchable draw solute 120 streams.

The exact steps used for the recovery process will vary depending on the non-ionic state of the switchable draw solute at standard ambient conditions, being a gas, liquid, or polymer. An approach to each state will be described below.

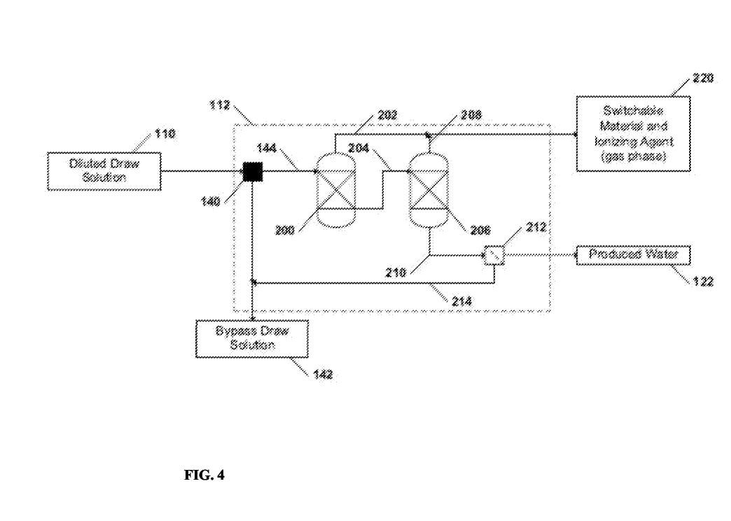

Referring to FIG. 4, the process shown here is the invention's embodiment for the recovery system 112 when the switchable draw solute is a gas phase material, such as trimethylamine. Following the split 140 of the diluted draw solution 110 to the bypass stream 142, the remaining material enters a separation unit 200. The separation imparts energy into the diluted draw solution to force the ionizing agent out of its ionized state and into a gas state; to maintain charge balance, the switchable draw solute also reverts from its ionic state to non-ionic state which has a propensity to be driven out of the water solution. This separation requires thermal energy which can be provided by internal or external heat sources, or through the addition of steam. The process unit 200 may be a closed vessel, a mixing vessel, a packed column, a tray column, a distillation column, or others as embodied in this invention. The gas product 202 will be rich in the switchable draw solute and the ionizing agent. The liquid phase 204 will be dilute in the ionizing agent and switchable draw solute. If a single process unit is insufficient to achieve high recovery of the ionizing agent and switchable draw solute, additional units, such as process unit 206, can be added in series to further process the liquid phase. These additional units may be the same as process unit 200 or can be different technologies. The resulting gas phase 208 joins with the first gas phase 202 and is returned to the regeneration process as a common gas stream 220 (representing the combination of ionizing agent stream 116 and switchable draw solute stream 120 on FIGS. 1 through 3). The remaining liquid stream 210 may still contain levels of ionizing agent and switchable draw solute that are unsuitable for the produced water or a downstream process, so additional purification stages 212 can be used to remove the bulk of these trace materials to create produced water 122 of desired quality. In this embodiment, such processes may include low pressure reverse osmosis membranes. The reject 214 from the additional purification stages 212 is mixed with the bypass draw solution 142 and sent to the regeneration process.

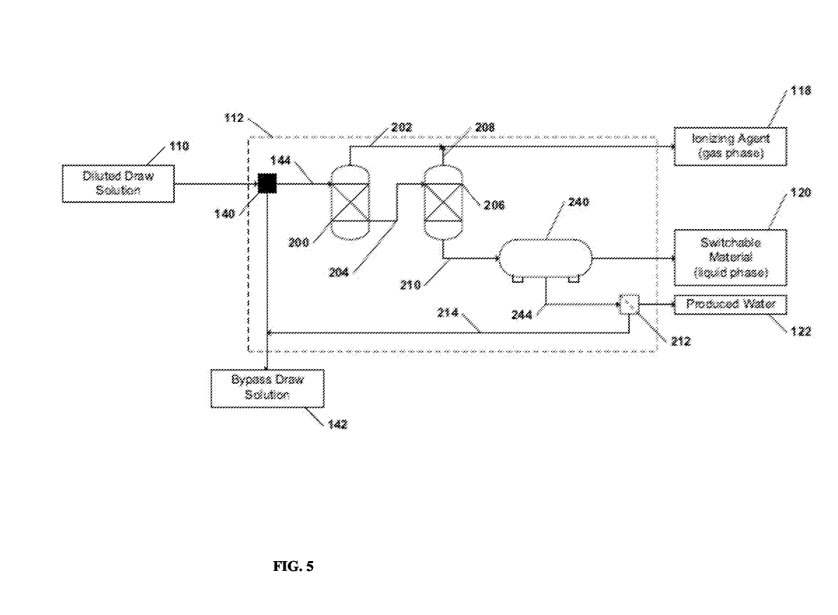

Now referring to FIG. 5, the process shown here is the invention's embodiment for the recovery system 112 when the switchable draw solute is a liquid phase material, such as 1-cyclohexylpiperidiene. The recovery process for the liquid switchable draw solute follows the same initial steps as for the gas switchable draw solute in FIG. 4, using separation process units 200 and 206. In this situation, the liquid products 204 and 210 will be rich in the switchable draw solute. With near complete removal of the ionizing agent, the final liquid product stream 210 will contain two immiscible phases: the hydrophobic switching material as one phase, and produced water as a second phase. These are separated using a physical separation process unit 240 such as a decanter or centrifuge. The recovered switchable draw solute 120 is sent to the recovery process, while the produced water 244 may pass through additional purification stages 212 to remove any trace switchable draw solute remaining. The gas products 202 and 208 from the separation units 200 and 206 will be rich in ionizing agent and should have trace levels of water and the switchable draw solute. These streams serve as the recovered ionizing agent 116 for the regeneration system.

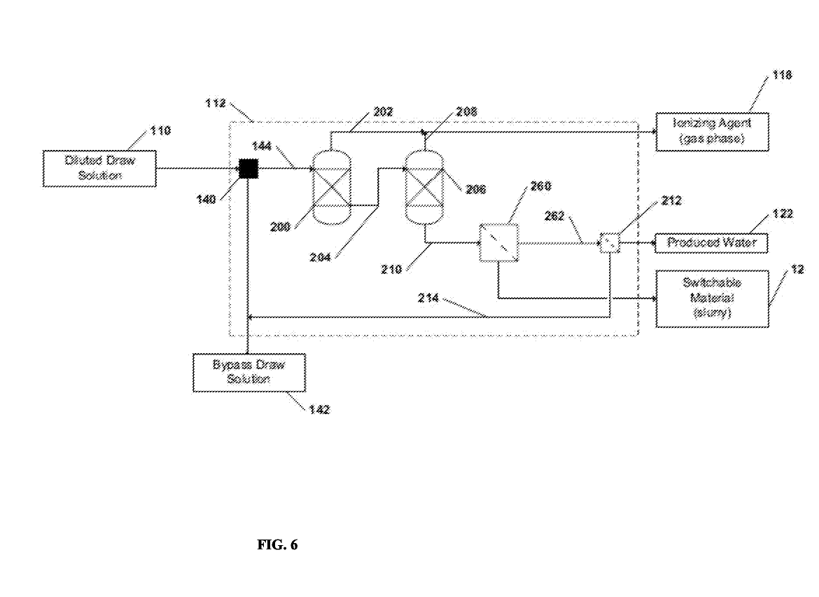

Now referring to FIG. 6, the process shown here is the invention's embodiment for the recovery system 112 when the switchable draw solute is a polymer such as a polyamine. The initial stages of the recovery process follow as above for the liquid switchable draw solute. The liquid products 204 and 210 from the separation stages 200 and 206 will be water with suspended polymer material. The separation of this material from water is done in a separation unit 260, which may be a membrane filtration device (including microfiltration and nanofiltration), low-pressure reverse osmosis unit, or a settling tank if the polymer does not remain suspended in solution. The large size of the polymer molecules will prevent passage through a typical membrane and will be easily separated as a slurry and used as the switchable draw solute 120 for the regeneration process. The resulting product water stream 262 may require additional purification 212 to remove trace polymer sub-systems.

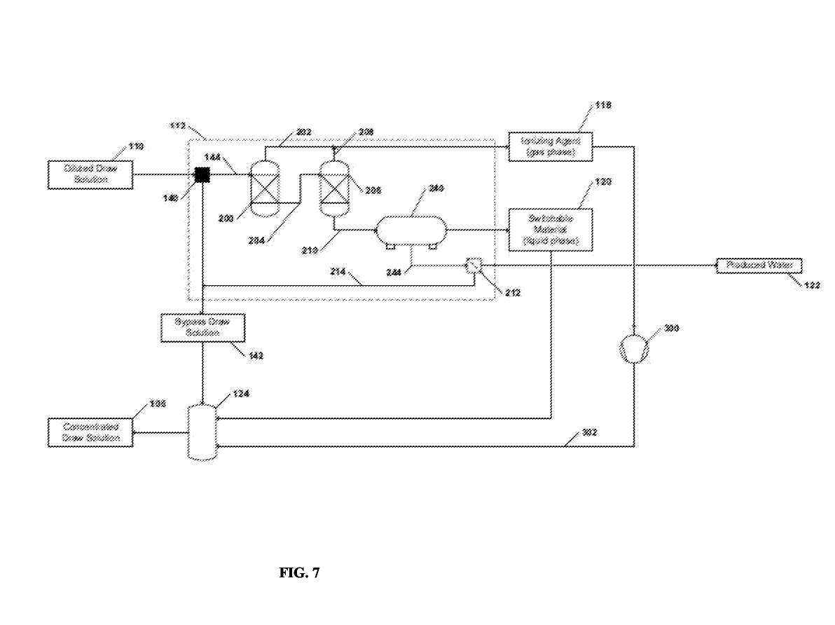

FIG. 7 shows the embodiment of this invention in which a vacuum has been applied to the gas phase of the recovery process. Though FIG. 7 demonstrates this specifically for the configuration where the switchable draw solute is a liquid as shown in FIG. 5, this embodiment can be applied to the other forms of the switchable draw solute. A vacuum pump 300 is used to create a vacuum upstream in the separation process units 200 and 206 through the produced ionizing agent gas stream 116, and delivers the recovered gas 302 to the regeneration unit 124 at near-atmospheric conditions. In the preferred embodiment, the generated vacuum in the separation process units 200 and 206 is between 0.4 and 1 atm absolute pressure, and more preferred between 0.5 and 1 atm absolute pressure. This has the effect of reducing the temperature in which separation of the ionizing agent from the diluted draw solution can occur through phase equilibrium. In separation processes where steam may be used such as for a stripping column, the lower pressure also reduces the temperature which saturated steam can be generated. Both effects of reduced pressure make it easier to use low-quality heat sources from the FO water treatment sub-system, from other water treatment sub-systems on the overall system, or from external sources to drive the separation process. In the embodiment where the switchable draw solute is a gas, both the ionizing agent and the switchable draw solute will be recovered in a common gas stream 220 (on FIG. 4). The vacuum pump would be placed on this line instead.

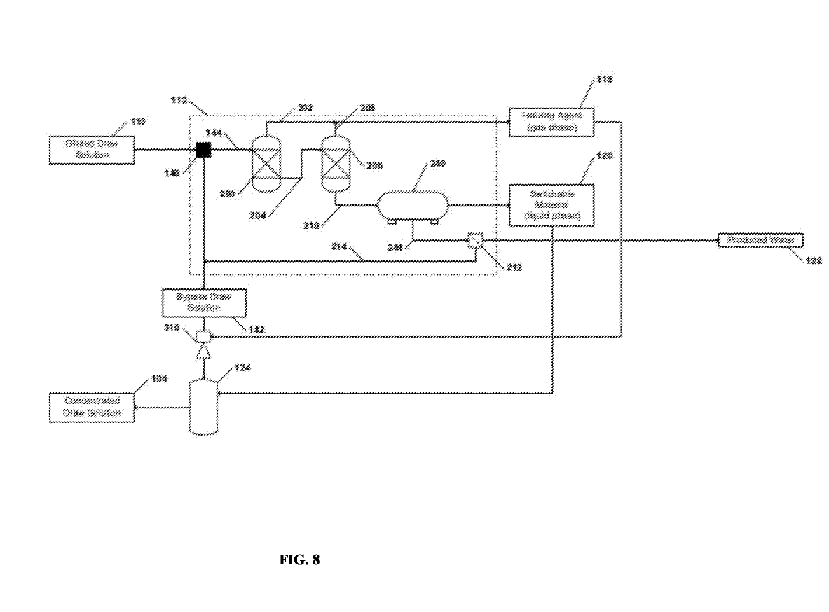

FIG. 8 shows a further embodiment of the vacuum system shown in FIG. 7. In this embodiment, the vacuum pump is an ejector 310 placed on an aqueous line; FIG. 8 demonstrates this on the bypass draw solution line 142, but the ejector 310 may also be placed on other lines up to the concentrated draw solution 106. The flow of fluid through the ejector 310 creates a Venturi effect that will draw in gas from the ionizing agent gas stream 116, creating a vacuum condition in the separation process units 200 and 206. This also has the effect of delivering the ionizing agent (and the gas-based switchable draw solute in that embodiment) to the regeneration process 124. As ejectors do not require external energy input and rely on the kinetic energy in the movement of the water stream, this embodiment should further reduce the energy requirements for the overall FO water treatment sub-system.

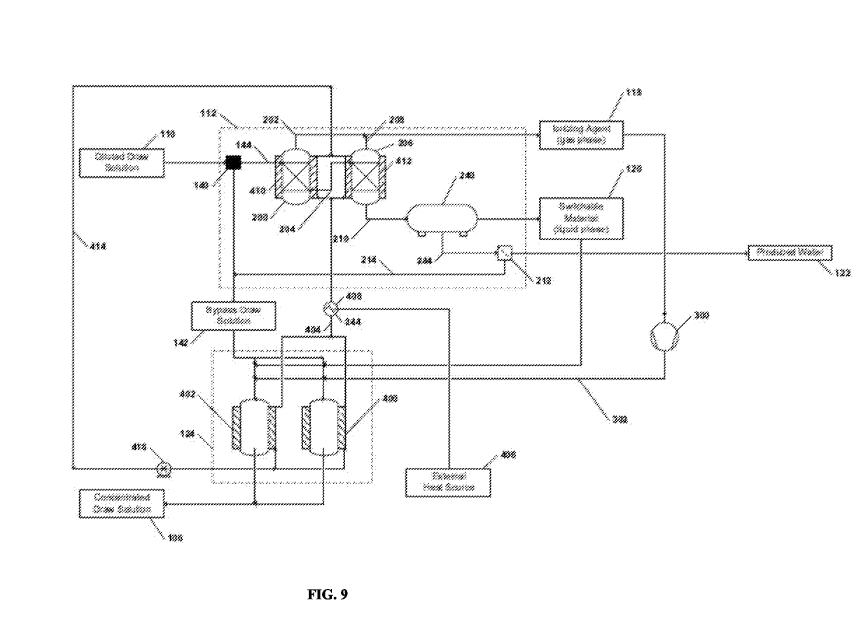

Turning now to FIG. 9, this drawing demonstrates one possible embodiment of heat reuse with the FO water treatment sub-system and from external sources within the overall water treatment system or external systems. This flow diagram is based on the embodiment using a liquid switchable draw solute but can be applied to all switchable draw solutes described in this invention. The regeneration process 124 is exothermic. The process unit will consist of at least one vessel 400, and may include additional vessels 402 for mitigation of the heat generated by the regeneration process. This heat is captured by a heat transfer fluid 404 like water or refrigerant, using cooling jackets or internal coolant coils. The heat is taken to the recovery process 112, where it is then distributed to heat the recovery process units 200 and 206, through heating jackets or internal heating coils (410, 412). The cold heat transfer fluid 414 is recycled back through the process through a pump 416. Additional heat energy is expected to be required for recovery than for regeneration, as the added water in the dilute draw solution will absorb some of the heat energy. Addition heat energy can come from electrical sources. In a preferred embodiment, the additional required heat can come from an external heat source 406, which can be either heat generated from other sub-systems within the overall water treatment system, or from external heat sources to the overall water treatment system, such as a combustion flue gas from an industrial process. The process shown in FIG. 9 is representative of such heat integration, and those skilled in the art will recognize that other configurations for heat integration between these processes can exist. For example, if the recovery process units 200 and 206 are stripping columns using steam, the steam can be generated from the heat recovered by the heat transfer fluid 404; the steam will subsequently transfer this heat directly to the dilute draw solution.

The embodiment of this invention uses a membrane system 108 that can include one or more membranes in various configurations, including serial, parallel, and combinations thereof. Currently, the only data for the performance and durability of membranes suitable for switchable FO systems are for proof-of-concept. These preliminary results show potential for these systems, but do not yet fully demonstrate membrane performance or durability under long term operations or at scale. Some results have identified poor material compatibility between concentrated draw solutions of switchable solutes and existing RO membranes due to the solution's caustic nature. It is expected that durable membranes will be engineered to work with switchable draw solutions, but at the present, there is no commercial solution. The concept of the membrane configuration in this invention is to be able to use the best membrane options available in a performance and cost optimizing manner to make switchable FO systems effective, low-energy water treatment systems.

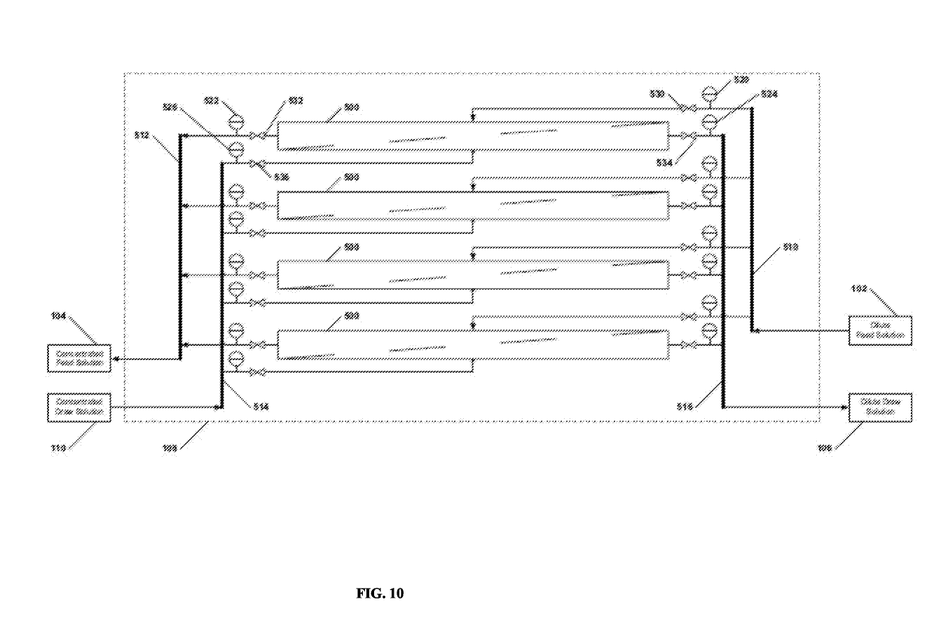

In one embodiment as shown in FIG. 10, the membrane modules 500 are operated in a parallel configuration; this figure shows a representative configuration with 4 membrane modules, but this configuration can use any number. The individual membrane units should have comparable size, capacity, and performance specifications. The feed water (diluted feed solution) 102 is passed through a flow manifold unit 510 to distribute the water flow equally to the modules; the concentrated feed solution is collected through a manifold 512 to recombine the streams as rejected concentrated feed solution 104. Similarly, the concentrated draw solution 106 is passed through a separate flow control manifold 514 to equally split the flow between the membranes, and the diluted draw solution is collected in another manifold 516 for the combined diluted draw solution 110. The configuration shown in FIG. 10 presents the draw solution flow as counter-current to the feed solution through the membranes, but it should be apparent to those skilled in the art that the draw solution may also be run co-current to the feed solution, or when using stacked flat-plane membranes, cross-current to the feed solution. The direction that the draw and feed solutions will take through the membrane modules will be a function of the module and system design.

In the parallel module configuration in FIG. 10, the preferred embodiment of this invention includes the use of sensors located on the inlet and outlet for both the feed and draw solutions on each module (520, 522, 524, and 526). The sensors include one or more sensor devices which measure the physical and chemical properties of the solution. These include, but are not limited to: temperature, pressure, flow rate, pH, conductivity, and chemical composition, with other options documented in the embodiments of this invention. A control system on the FO water treatment sub-system monitors these sensors against predetermined values based on design conditions and expected membrane operations, and will perform actions such as sending out alerts to operators when such readings are outside of design scope. For example, comparison of sensor measurements of pH or conductivity between the inlet and outlet on the same side of the membrane can be used to determine the change in concentration of that solution. If the concentration change falls below pre-determined nominal values, this may indicate that the membrane has become fouled or that a rupture of the membrane has occurred, requiring maintenance or replacement. In a more preferred embodiment of this invention, there are also isolation valves (530, 532, 534, and 536) located on the inlet and outlet of the feed and draw solution flows. These valves can isolate the feed and draw solution flow from the affected membrane, allowing for it to be maintained or replaced while the FO water treatment sub-system can continue to run at diminished capacity. In some configurations, there exists at least one additional membrane module that would normally remain isolated from the feed and draw solution flows. When a module is isolated for maintenance and repair as previously described, one of these isolated membrane modules is then brought online by opening its isolation valves. When the newly-isolated module has been maintained, repaired, or replaced, it can remain isolated from the feed and draw solution flows, becoming the available module to engage when a separate membrane module fails.

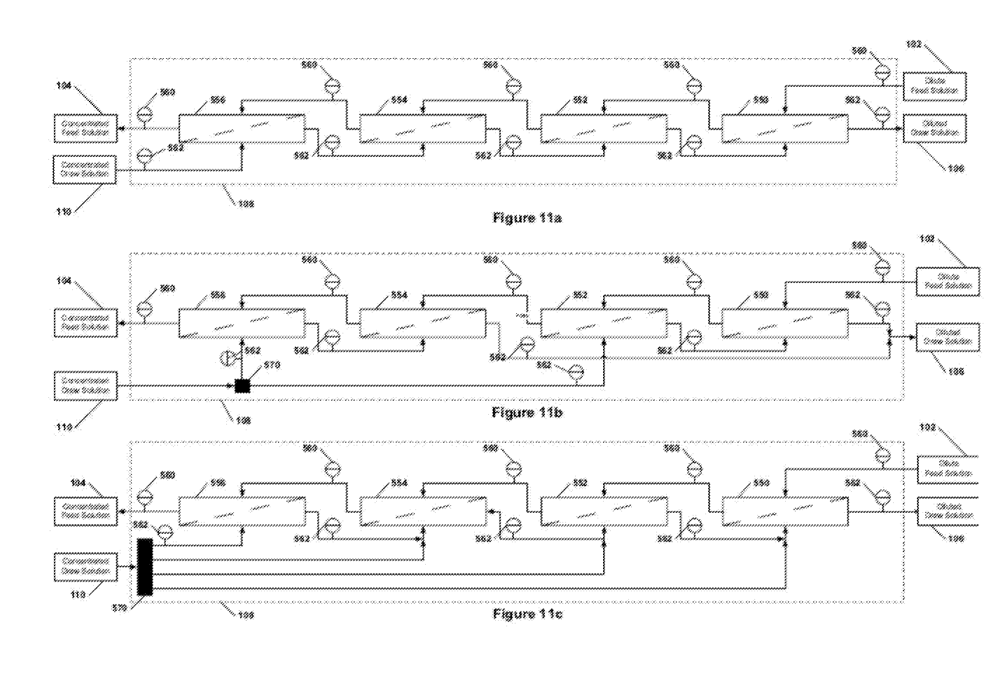

Now referring to FIG. 11, another embodiment of the membrane module 108 configuration is by having two or more modules in series. Three potential configurations are shown in this figure. FIG. 11a is a representative arrangement showing four membrane modules (550, 552, 554, and 556) in series, but any number of modules may be used here. The membranes do not need to be of equivalent size, capacity, or performance in the series configuration. FIG. 11a shows an arrangement where the flow of draw solution to each membrane module is in counter-current flow to the feed water; co-current and cross-current arrangements may also be used. It is not required to use the same arrangement for all modules in this configuration.

FIG. 11a shows one possible flow pattern for the feed solution and the draw solution through the series of membranes. This arrangement is of generally a counter-current nature: as the draw solution becomes more diluted as it moves downstream, it is reused on membranes with more diluted feed solution, or on modules upstream within the feed solution flow path. This flow arrangement is necessary to take advantage of the osmotic pressure difference between the draw and feed solution for FO and maintain a high driving force and water flux across each membrane. There are similar methods of routing the feed and draw streams through the modules to take advantage of draw-feed osmotic pressure differences. For example, FIG. 11b uses the same four-module configuration as FIG. 11a, retaining the same feed solution flow path. The draw solution flow path is distributed into two streams via a flow distributor 570, with one stream entering at module 556 and then through 554, while the other stream enters in 552 and then through 550. Both diluted draw solution feeds are recombined for processing in the recovery system. This approach enables the high osmotic pressure of the draw solution to be applied at multiple points along the feed solution path, enhancing the recovery of water from the more concentrated feed solution system.

FIG. 11c shows a further embodiment of this invention, where the draw solution is split by the flow splitter 570 among all four modules through a distributed system. In this manner, the concentration of the draw solution is boosted after each module, thus increasing the osmotic pressure difference across each module high. The split of draw solution does not need to be equal to each entry point, and can be designed to match the module's capacity and expected water draw at that point.

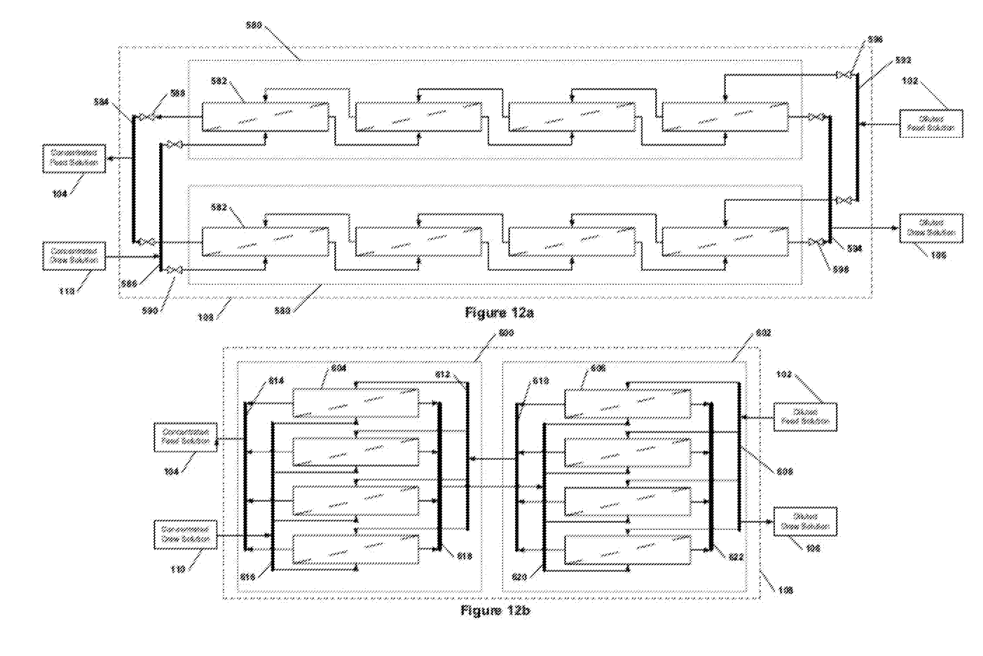

Now turning to FIG. 12, another preferred embodiment of the membrane module 108 is a combination of the series and parallel systems described in FIGS. 10 and 11. For purposes of simplicity, FIG. 12a omits sensor instrumentation that has been shown in the previous figures. FIG. 12a demonstrates one representative configuration where there is a parallel arrangement of a number of modules in series. In FIG. 12a, a membrane module 108 incorporating two equivalent sub-module systems 580 are arranged in parallel, where each sub-module system includes four membrane units 582 in series. As with the parallel configuration of FIG. 10, flow distributors 584, 586, 592, and 594 are used to manage the flow between the two 4-membrane units 582, with isolation valves 588, 590, 596, and 598 used to segregate one of the 4-membrane units for maintenance and repair. In one possible embodiment, the first membrane in each parallel sub-module system 580 is of the same material and construction, while the second membrane can be of a different type. This enables the discretization of the membrane draw within individual subsystems, with the ability to isolate any two-module sub-system if there are problems with one of the membranes.

FIG. 12b demonstrates a representative configuration where there is a serial arrangement of modules in parallel. For purposes of simplicity, instrumentation and valve placement previously described are not shown in FIG. 12b. In FIG. 12b, there are two sub-module systems: 600 and 602. Each sub-module has four membranes, 604 and 606, respectively. Each membrane 604 in sub-module 600 is equivalent in material and construction; similarly each membrane 606 in sub-module 602 is equivalent. However, it is not required that the membranes 604 and 606 are of the same type. Flow of the feed solution is distributed and collected through manifolds 608, 610, 612, and 614, and flow of the draw solution is distributed through manifolds 616, 618, 620, and 622. In this configuration, the water draw is discretized over two different membrane types, using the parallel sub-module systems to increase the net membrane surface area and capacity of each sub-module. This situation is demonstrated further in Example 2.

Numerous similar configurations from those shown in FIGS. 10, 11, and 12 are possible. The optimal configuration for both operating efficiency and capital and operating costs will depend on several factors, including the feed water salinity, the draw solute and draw solution configuration, physical and chemical properties of each membrane, and the efficiency of the recovery and regeneration portions of the forward osmosis water treatment sub-system.

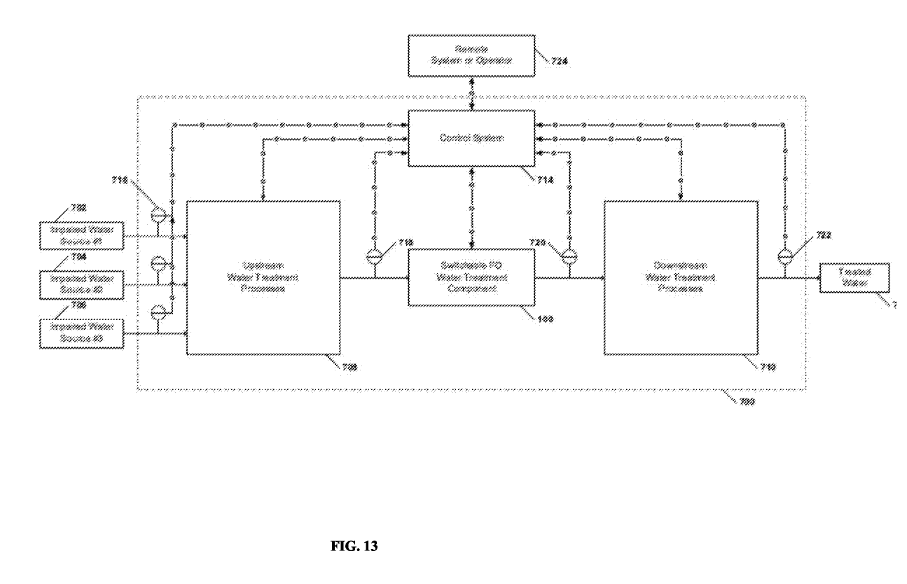

The embodiment of this invention is the incorporation of the FO water treatment sub-system, in any of the configurations as described above, into an overall water treatment system. FIG. 13 demonstrates the general process flow for the embodiment of this involved. The overall water treatment system 700 takes water from one or more feed sources 702, 704, and 706. In the preferred embodiment of this invention, these sources can include industrial or commercial waste water, tertiary treated water, seawater, groundwater, water from bodies of waters such as rivers or lakes, produced water from oil and gas production, and water used for mining or fracking operations. A number of upstream water treatment sub-systems 708 are used prior to the FO water treatment sub-system 100, and additional treatment is performed by downstream units 710 to produce the cleaned-up water supply 712. All sub-systems are in communication with a control system 714; the control system performs both monitoring and control of the individual water treatment sub-systems including the FO water treatment sub-system 100, and also monitors sensors placed on the incoming water feeds 716, intra-process water streams 718 and 720, and produced water streams 722. The control system 714 is also in communication with a remote system or operator 724. The remote system or operator logs data and control decisions made by the control system, and can relaying desired operating changes set by the remote operator to the water treatment system. It can also receive data regarding external parameters such as weather conditions or expected water usage, enabling the overall water treatment system to operate in anticipation of the effects on upstream water or downstream delivery. In the embodiment of this invention, the FO water treatment sub-system 100 is controlled in a manner to respond reactively to variations and fluctuations in the incoming water feeds 702, 704, and 706 that other water treatment sub-systems on the overall system 700 cannot mitigate.

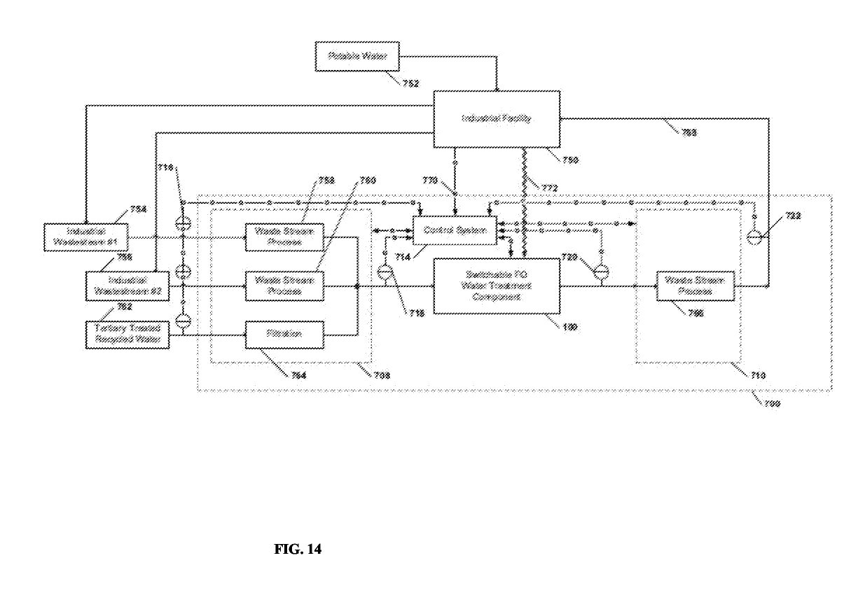

Turning now to FIG. 14, this shows one example embodiment of this overall water treatment system. An industrial facility 750 uses potable water 752 to perform numerous industrial processes, generating one or more waste streams 754 and 756. These waste streams are normally treated through established water treatment systems 758 and 760 to bring the composition of the wastewater into specifications required to be dumped into a local sewage system. Such processes might include metals recovery, removal, or destruction, operating in various series or parallel configurations. In this embodiment of this invention, the overall water treatment system 700 encompasses these treatment systems as part of the upstream water treatment sub-systems 708. In addition, water from a tertiary treated recycled water source 762 is processed in the upstream sub-systems 708, specifically including filtration 764. The combined effluent of all the treatment processes in 708 are sent to the FO water treatment sub-system 100 which is able to handle the potentially large variation in composition that the wastewater and recycled water streams present. Further polishing is performed in one or more downstream sub-systems 710, specifically including processes like UV treatment to remove biological components 766. The produced water 768 at this state will be of quality that meets or exceeds for potable use within the industrial processes at the facility 750, allowing this water to offset the required amount of potable water 752 that is needed, as well as reducing the amount of water going to sewage. Further, the control system 714 on the overall water treatment system 700 can receive data 770 about the industrial plant operation as to prepare the individual water treatment sub-systems, including the FO water treatment sub-system 100, for any upstream variations. A further benefit is that any low-grade heat generated by the industrial facility can be rerouted as a heat source 772 to be used to recover the diluted draw solution in the FO water treatment sub-system 100 as previously described.

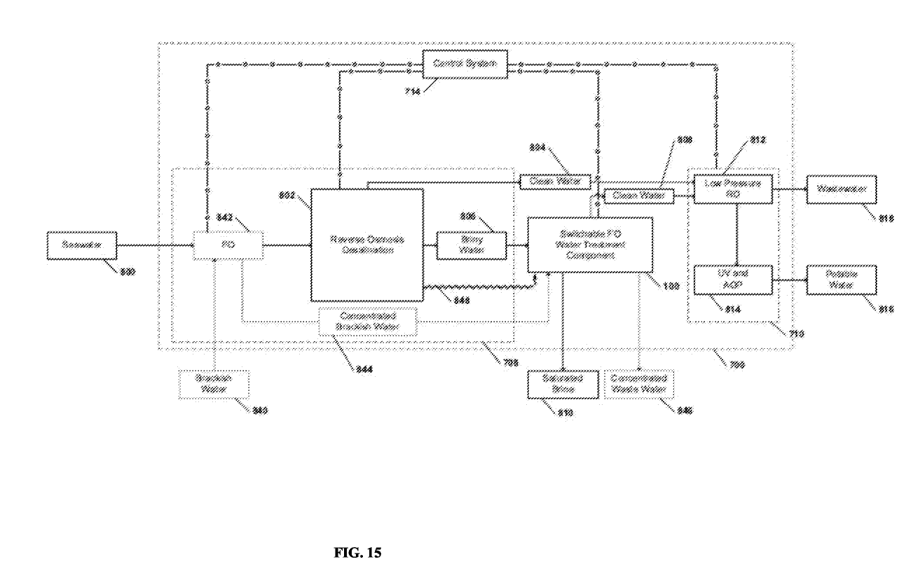

Turning now to FIG. 15, this represents another embodiment of this invention, a system 700 for the desalination of seawater to produce potable water. There are many large scale desalination plants based on mature RO processes, and it is unlikely that switchable FO will be an immediate replacement for these systems until the technology gains similar maturity. Switchable FO water treatment systems can be beneficial for existing RO systems by operating on the reject brine from the RO system to extract more water from this stream without requiring a significant amount of energy. An example of such a system is shown in FIG. 15, and is further described in Example 7. Seawater 800 is put through a reverse osmosis system 802 to produce clean water 804 and briny wastewater 806. Reverse osmosis is limited by the maximum applied pressure that can be effectively applied given material constraints, so the briny wastewater 806 will only be about 7-8 wt % salt content, compared to 3.5 wt % in the seawater 804. The FO water treatment sub-system 100 can extract more water from the briny wastewater 806, producing further clean water 810 and a saturated brine stream 812, with 20-25 wt % salt concentration. Both clean water streams from the RO (804) and FO (810) are subjected to a final cleanup stage 714. This stage includes a low-pressure RO system 812 to remove remaining salt and other inorganic components from the water, and final polishing unit 814 consisting of, at minimum, a ultra-violet (UV) system and an advanced oxidation process (AOP) are used to destroy remaining organic materials to make the water safe for potable uses. In considering the water recovery from seawater (the percent of water present in the seawater that is produced as potable), an RO system has a typical maximum effective recovery of 50%. With the addition of the FO system to pull additional water from the briny wastewater of the RO unit, the water recovery efficiency can increase to 90%. Additionally, the brine waste stream 812 has reuse potential in other industries.

A further embodiment in FIG. 15 is the addition of an FO unit 842 upstream of the RO unit 802 as described in U.S. Pat. No. 8,216,474. Error! Bookmark not defined. This FO unit does not need to be based on the switchable draw solution described in this patent, but instead could use a feed stream 840 with higher salinity than seawater, such as brackish industrial wastewater, as the draw solution. The osmotic pressure different between the wastewater stream 840 and seawater 800 will cause water to draw from the feed stream into the seawater, diluting it. This has been shown to reduce the amount of energy required in the subsequent RO unit 802. This produces a more concentrated wastewater stream 844. As long as this stream has a lower osmotic pressure than the draw solution within the switchable FO water treatment sub-system 100, it is possible to further recover water from this stream. This can be done in the same process unit as with the briny water recovery (producing only one wastewater stream 846) or separately (producing separate brine 812 and concentrated wastewater 846).

A final embodiment demonstrated in FIG. 15 is the potential for heat reuse within the overall water treatment system 700. While RO systems operate at ambient conditions, they required a large amount of power to operate pumps to apply high hydraulic pressure, which many generate thermal energy 846. This energy can be reused by the FO water treatment sub-system 100 to reduce the energy requirements for draw solution recovery.

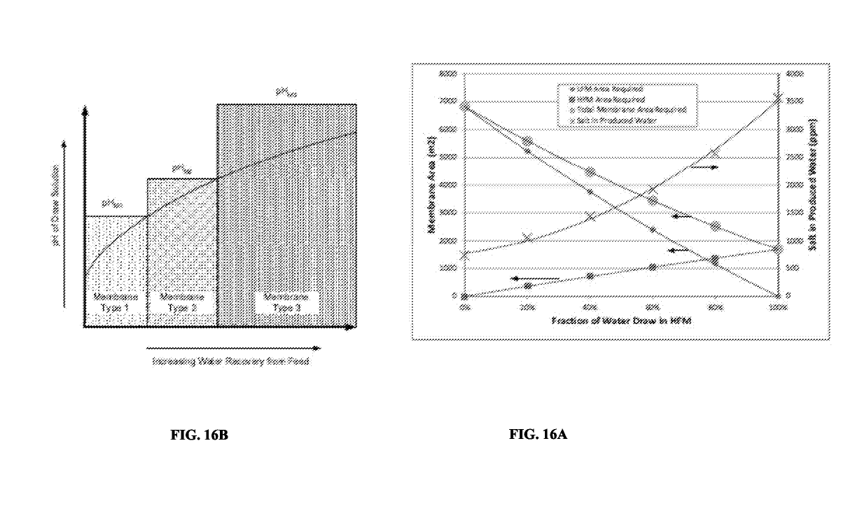

FIGS. 16a and 16b are described in more detail in Example 2 below.

### EXAMPLES

### Example 1

### Effect of Concentration on pH and Performance of Switchable Draw Solution

Switchable draw solutes, once activated by the ionizing agent, are generally very basic in water, with pH values of 9 or more. Their pH increases with higher concentrations and osmotic pressures. While higher osmotic pressures are desirable, the pH of highly concentrated draw solutions may create chemical incompatibilities with the membrane that can cause degradation. This situation is further impacted by the presence of the internal concentration profile (ICP) that occurs within forward osmosis membranes that use a support and active layer. The local concentration of the draw solute will be higher at the boundary of the active and support layer than in the bulk draw solution, and the pH will become more caustic, leading to potential damage of the active layer. This example demonstrates the overall impact of solution concentration on water recovery performance for the FO system and the draw solution's pH and its effects on the membrane selection and durability.

In this example, the switchable draw solute is N,N-dimethylcyclohexylamine (DMCHA), an immiscible liquid in water. The material has been previously evaluated as a draw solute for forward osmosis Error! Bookmark not defined. At lab scale, a 59 wt % DMCHA solution, with an osmotic pressure of 275 atm, was able to generate a water flux across a cellulous triacetate (CTA) membrane from a 3.5 wt % NaCl solution of 21 L/hr/m2.

Calculations were performed to demonstrate the scaling-up of these results to a representative large scale FO system. The calculations used a one-dimensional finite element approach to account for the changes in draw and feed concentration and the effect on osmotic pressure along the length of the membrane. In both cases the feed and draw streams are each operated at 2000 gal/min prior to the membrane in a co-current flow; counter-current or cross-current flow arrangements would be expected to demonstrate higher flux.

Table 1 presents calculated performance data for the forward osmosis membrane based on this data, with the draw solution drawing water from a 3.5 wt % NaCl solution (approximating seawater) through a CTA membrane. The table lists, for each case, the initial osmotic pressure differential at the inlet side of the membrane, the necessary membrane area required to draw 1000 gal/min of water from the salt solution to the draw solution, the average water flux over the membrane area, and the initial pH of the concentrated draw solution (prior to the membrane) for various initial concentrations of the draw solute. The pH values were estimated using the established pKa value of 10.48 as reported by J. R. Vanderveen et al.

TABLE 1
Membrane Performance and pH of Draw Solution at Various Concentrations

| | Initial | | Water | |
|---|---|---|---|---|
| | Osmotic | Membrane | Flux | pH of |
| Wt % | Pressure | Area | (average) | Concentrated |
| of Draw | Differential | Required | (gal/ | Draw |
| Solution | (atm) | (m²) | min/m²) | Solution |
| 50% | 228 | 21,000 | 0.048 | 11.2 |
| 60% | 357 | 13,500 | 0.074 | 11.4 |
| 70% | 573 | 9,250 | 0.109 | 11.6 |
| 80% | 1,004 | 6,250 | 0.161 | 11.8 |
| 90% | 2,300 | 3,900 | 0.255 | 12.2 |

This table demonstrates that the more concentrated the draw solution, the more effective water draw it can have in forward osmosis, with an exponential improvement with increasing concentration. Osmotic pressure differentials of 500 atm or more are excellent features for an effective forward osmosis system. However, more concentrated draw solutions will become more caustic as noted by the final column showing the calculated pH values. Even at 50 wt %, the draw solution has a pH value that is out of range for many organic membranes; CTA membranes typically have an upper pH tolerance of 8. Organic membranes would readily degrade over time and may cause salt/ionic breakthrough, flux degradation, or breakthrough of the feed solution into the draw solution. Many switchable solutes have pKa values ranging from 9 to 12 and higher. Error! Bookmark not defined. In general, all switchable draw solutes will be strong bases in highly concentrated solutions that are desired for forward osmosis, and will require more durable membrane materials to process properly.

This example demonstrates the invention's use of alternate membranes that are able to tolerate higher pH values needed by these switchable draw solutes to obtain effective water recovery for high salinity water sources.

### Example 2

### Membrane Configuration Demonstration

One feature of this invention is the use of multiple membranes in various serial and parallel configurations. These configurations can be used to discretize the water draw across the membrane process as to optimize water recovery and salt rejections, and to help mitigate membrane durability issues that arise from the caustic switchable draw solvent use, as described in Example 1

To demonstrate the discretization, a finite-element simulation the system in FIG. 12b was performed in which two sets of parallel membranes, arranged in series. Inlet feed water was taken as simulated seawater, 3.5 wt % NaCl in water, at 100 gal/min. The draw solution was based on the DMCHA solute from Example 1, using a 50 wt % concentrated draw solution flowing at 150 gal/min. The target water production from seawater is to be fixed at 75 gal/min (75% recovery), which is obtained by varying the area of the two different sets of parallel membranes banks. It is assumed that each parallel bank is composed of equivalent membranes as to achieve the required membrane area.

Two different membranes are considered for the system in FIG. 12b. The membranes on the concentrated side of the process, 604, are chosen from a low flux membrane (LFM) material compatible with the concentrated draw solvent. The membranes on the dilute side 606 are chosen from a high flux membrane (HFM) material that is only compatible with the switchable draw solution at low concentration. The flows are set in counter-current flow: the draw solution passes through the LFM into the HFM, while the feed solution passes from the HFM to the LFM. This approach matches the concentrations between the draw and feed to keep a more consistent osmotic pressure differential between the two sides of the membrane.

To simulate the membranes, assumptions were made on the membrane performance. There is a lack of data on the performance of draw solutes over different types of membranes. The water flux for FO membranes using switchable draw solutes will need to have a permeability from 5 to 20 L/hr/m2 (1.32 to 5.28 gal/hr/m2) to be competitive with salt-based FO systems. Further, salt rejection rates will need to be at least 95% for similar competitiveness. For this example, the LFM is assumed to have a water flux of 5 L/hr/m2 at an osmotic pressure differential of 200 atm with a salt rejection ratio of 99%. The HFM is assumed to have a water flux of 20 L/hr/m² at 200 atm, with a salt rejection ratio of 95%.

Several cases were calculated based on what fraction of the target 75 gal/min water flux was performed by the HFM. For example, with this fraction at 40%, then the HFM is sized to draw 30 gal/min of water, and the remaining 45 gal/min from the LFM. The required area for each membrane was calculated through a finite element approach, estimating the changes in the osmotic pressure differential and the permeability rate as the feed and draw solution concentrations changed. The amount of NaCl that passes into the draw solute was also calculated for each case based on the salt rejection for each membrane.

Table 2 lists the result of each simulation based on the fraction of water draw that is handled by the LFM. This data is also illustrated in FIG. 16a.

TABLE 2
Calculated Estimated for Required Membrane Area and Produced Water
Purity in Various Serial Membrane Configurations for Fixed Water Recovery

| Fraction | | | | | | |
|---|---|---|---|---|---|---|
| of Water | Total | Total | | | | Draw |
| Draw | LFM | HFM | | NaCl in | | Solvent |
| Handled | Area | Area | Total | Produced | Draw Solvent | pH |
| in HFM | Required | Required | Membrane | Water | Concentration | after |
| Modules | (m²) | (m²) | Area (m²) | (ppm) | after LFM | LFM |
| 0% | 6826 | — | 6826 | 733 | 27.4% | 10.8 |
| 20% | 5219 | 370 | 5589 | 1053 | 30.1% | 10.8 |
| 40% | 3746 | 717 | 4463 | 1437 | 33.4% | 10.9 |
| 60% | 2403 | 1044 | 3447 | 1919 | 37.6% | 11.0 |
| 80% | 1171 | 1358 | 2529 | 2568 | 42.9% | 11.1 |
| 100% | — | 1686 | 1686 | 3567 | 50.0% | 11.2 |

This data shows that in maintaining the same water flux in each case, there is a tradeoff between the amount of membrane area required to complete that flux, and the quality of the recovered water. These tradeoffs would have to be evaluated in the context of capital and operating costs. These cases all share similar capital and operating costs for the recovery and regeneration processes in the FO water treatment system, and the cost difference would be within the membrane system and any post-treatment processes. While lower membrane area is generally desirable to reduce costs, the high salinity of the produced water may not be suitable for all applications. Additional treatment options may be necessary to further reduce the salinity of the produced water. This presents added capital and operational costs. It is necessary to optimize how to discretize the membrane system to meet water purity requirements and other process needs.

Further, the compatibility between the draw solution and the membrane can influence the membrane discretization optimization. To demonstrate with the above example, the assumption that the HFM has a safe operating pH range up to 11.0, while the LFM can safely operation up to a pH of 14.0. Under these conditions, it would be impractical to use only the HFM (the 100% case) as the pH of the draw solvent exceeds the membrane's safe pH operating range and would lead to membrane deterioration. It is only practical when 40% or less of the water is recovered by the HFM. In this case, the amount of water drawn through the LFM is sufficient to dilute the draw solution to a pH level below the HFM's safe operating limit. It is possible to use the LFM for 100% of the water draw (or 0% of the water draw through the HFM), but this can also become cost-prohibitive if the LFM membrane is costly relative to the HFM cost.

This concept is generalized in FIG. 16b. The curve on FIG. 16b represents the change in pH of the concentrated switchable draw solution required to pull water from the concentrated feed as more water is recovered from the feed solution This alternatively can be seen as the change in pH in the draw solution (vertical axis) along the length of the membrane water recovery process (horizontal axis). In this figure, three different membranes are presented, each with different performance metrics and compatibility with the switchable draw solution. The maximum pH tolerance for each membrane is given as pHM1, pHM2, and pHM3; the shaded boxes represent the safe operating range for each membrane. In general, membranes with lower pH tolerance will generally have better water permeability performance. It is possible to use the most durable, low flux membrane (Type 3) for the entire water draw, but this could require a very large membrane area requirements and costs, as demonstrated in the table above. Instead, the membrane discretization concept in this invention allows one to stage the membranes in series along the water recovery process as to optimize the use of each type of membrane to maximize the overall water recovery. Feed water would contact membrane type 1, the most effective but least tolerable. The design of this membrane would assure good water flux while staying below the maximum pH tolerance with the draw solution. The second membrane of type 2 uses the concentrated feed effluent from the first membrane against a more concentrated draw solution. Again, this membrane would be designed and sized to draw as much water across without exceeding the pH tolerance of the membrane. The third membrane, the most durable type, can then complete the rest of the water recovery from the feed while remaining durable against the highly concentrated draw solution. In general, the goal of the design is to assure that the pH curve on FIG. 16b never extends beyond the bounds of the safe operating range shown by these boxes.

There is additional optimization that would be required to evaluate the best use of membranes in this case, particularly relating to capital and operating and maintenance costs. The concept of discretizing the membranes remains the same, determining how to section off the water recovery to use each membrane within its operating requirements while achieving highest performance and costing. The membrane discretization enables the ability to find optimal use cases for different types of membranes.

### Example 3

### Draw Solution Osmotic Pressure Adjustment in Response to Upstream Fluctuations

Another feature of this invention is the manner of adjusting the concentration of the switchable draw solution to manage its pH, osmotic pressure, and other properties in response to changes from upstream systems. Most external water feeds, such as secondary or tertiary wastewater, seawater, or industrial wastewater, will have highly fluctuating compositions due to numerous factors, generating potentially large osmotic pressure changes. These changes will impact the draw of water through the forward osmosis membrane, with the draw declining with increased feed water concentration. The chemistry and properties of the switchable draw solutes described in this patent enable the ability to control the osmotic pressure of the draw solution to match these changes upstream or altering the method of regeneration.

An ASPEN model was run using a simulation of the FO sub-system, based on the draw solute 1-cyclohexylpiperidine (CHP). The feed water was initial set to 3.5 wt % NaCl to simulate seawater. The draw solution in its concentrated, ionic form was 60 wt % CHP-CO2; this has a calculated osmotic pressure of 365 atm. The feed water flow was set at 1000 gal/hr, and the draw solution at 750 gal/hr. The membrane was assumed to operating in counter-current mode, and designed under the conditions to draw sufficient water across the membrane to halve the osmotic pressure of the draw solution (to 182 atm). The regeneration process splits 50% of the draw solution to be regenerated, with a 99% recovery of CHP and CO2. Under these conditions, the process is able to produce 774 gal/hr of produced water (77.4% recovery). These are not fully optimized conditions but used to demonstrate this example.

If the feed water concentration increases, the amount of recoverable water will decrease assuming no other changes in operating conditions and that the membrane flux remains linear with respect to the osmotic pressure differences. An increase from 3.5 wt % to 5 wt % can reduce the recovered water from 774 gal/hr to 741.6 gal/hr, a 5% drop. Such fluctuations may be small in dilute water streams, but the produced water rate drop will become more dramatic when dealing with more concentrated feeds and with long-term input fluctuations. There is a need to handle feed water concentration fluctuations concentrations that occur in highly concentrated feed streams. The switchable FO system is well suited to handle these fluctuations due to the ability to alter the draw solution concentration described in this invention.

The flow rates of solutions across membranes are generally tuned to meet optimal conditions for the structure and design of the membrane module based on a set value for crossflow velocity. It is not ideal to change these flow rates, as this will change the hydrodynamics of the flow patterns at the membrane, influencing the osmotic pressure differential and the effects of the ICP and ECP. Instead, other methods to meet upstream changes should be found. When the feed water concentration changes, there are two inherent ways built into the switchable FO water treatment sub-system that can moderate the change and maintain a constant produced water flow. One method is by altering the fraction of diluted draw solution that is sent to the switchable draw solute recovery and regeneration process (the bypass fraction). More water can be extracted to maintain the constant product flow by changing this bypass fraction. This can create variations in the concentration of draw solution regeneration loop, but these are remedied through the use of a storage/buffer tank on the concentrated draw solution side to level out these fluctuations. In this example, the concentration of the draw solution is adjusted to keep the same consistent value within the regeneration process through makeup vessels to replenish the draw solution.

Table 3 lists various increases in the concentration of the feed water, and the required change to the fraction of diluted draw solution to that is used in switchable draw solute recovery as to maintain the same produced water flow.

Another operating parameter that can be changed is the concentration of the draw solution. In general, the draw across the membrane is a linear function of the osmotic pressure differential. The change in the feed's osmotic pressure can be offset by the application of an equivalent amount of osmotic pressure on the draw side. The osmotic pressure in the feed water increases from 27.85 atm to 40.94 atm when the concentration increases from 3.5 to 5 wt %. The difference in pressure change is about 13 atm, or 191 psi. With other technologies like RO, this difference can be extremely significant and potentially make it unfeasible for the system to handle this increase in concentration. With switchable materials as draw solutes, this difference can be met by increasing the draw solution concentration at the regeneration process. In this case, the concentration can be changed from 60 to 61 wt %, with the osmotic pressure increasing from 365 to 380 atm, based on ASPEN's property predictions. The draw solution concentration can be adjusted through several means, such as by adding more of the draw solute and ionizing agent during the regeneration process to increase concentration, or by rejecting a fraction of the recovered draw solute and ionizing agent from the recovery process to dilute the solution. Changes in the draw solution concentration may need to be accompanied by adjustments in the recovery and regeneration process, such as the fraction of diluted draw solution to be treated by these processes. Table 4 shows what changes in the draw solution concentration (in its concentrated, ionic form) and the fraction of diluted draw solution to be processed for recovery and regeneration, as to maintain the constant water production with changes in the feed concentration. The results demonstrate that consistent water recovery can be maintained against large fluctuations in the feed water inlet concentrate by making small adjustments on the draw solution concentration, a facet enabled by the use of switchable draw solutions.

This example shows to means of maintaining consistent water production by controlling the draw solution concentration. There are combinations of other options within possible configurations of the recovery and regeneration system of the FO water treatment sub-system to lessen changes upstream. This control mechanism also works with the membrane cascade concept as to maintain pH values within compatibility levels, using the less caustic draw solution concentration required to meet the required water recovery.

### Example 4

### Forward Osmosis Water Treatment System for Industrial Facility

This example demonstrates the use of the FO sub-system as part of a larger water treatment system. An industrial site that uses tap water for rinses from several different chemical processes has been extensively surveyed to determine water and chemical usage. The site uses about 26 million gallons of water on an annual basis. This is equivalent to 4,170 gal/hr on a continuous basis. Internally, used rinse water is segregated into four waste streams: general wastewater that is sent to sewage directly, wastewater rich in metal salts which is treated first prior to disposal to recover these metals, cyanide-rich wastewater that uses cyanide destruction technology to remove the cyanide before the sewage, and chrome-rich wastewater were the chrome is removed from the water before sewage.

The use of a water purification system is considered for this site to reduce its water consumption. There are three possible options that can be considered: 1) using water purification to internally recycle one or more of the waste streams into fresh water, 2) using tertiary treated (recycled or “purple pipe”) water as to offset tap water, or 3) a combination of these two options. This latter option is represented, generally, in FIG. 14. It is possible to configure this approach to fully replace tap water use with recycled and tertiary treated water, but this can lead to undesirable complications in long-term operation if there are significant variances in the tertiary treated water quality. For all cases, at least 100 gal/hr of tap/potable water was required as to have a clean water source at all times. In all cases, the goal is to have the combined tap water and the produced water from the water treatment system to have a water quality as good as or better than tap water as to avoid disrupting the site's existing operations, which require certain purities of water for their processes

The example considers all three cases, using a typical low-pressure reverse osmosis purification system, and using the forward osmosis purification system embodied by this patent. The industrial site and the water purification system have been modeled within ASPEN Plus system simulation software. The simulations include the use of single-stage, two-stage, and three-stage reverse osmosis units, which have, as a rule of thumb, a practical water recovery efficiency of 50%, 75%, and 85%, respectively, when operated at 100 psi. The simulations also evaluated a forward osmosis unit as described by this patent using a 60 wt % trimethylamine (TMA) as the draw solution. The water recovery efficiency from the FO system was assumed to be a conservative value of 75% and an aggressive value of 90%. The energy requirements for forward osmosis include internal heat recovery, but do not include the potential use of waste heat streams that the site can offer. In all cases, the energy cost for either the hydraulic pressure (for reverse osmosis) or for the draw solution recovery and regeneration (for forward osmosis) was considered to be 75% of the total energy requirements for the osmosis unit, accounting for controls, pumps, and other similar balance of plant equipment.

In all cases, the membrane processes were estimated with a 98.5% salt rejection rate for all ionic species in solution. This is a conservative value; while many membranes will have measured rejection rates for NaCl of 98.5% or better, the rejection rates for heavier ions will be even greater since these ions cannot readily pass through the membrane. The exact distribution of rejection rates is a function of the membrane type and manufacture. For this example, all ions are rejected at the same rate.

Table 5 lists the simulation results for each case, including how much tap water is required, and how much tertiary treated water is used. The amount of power required for the operation is also listed. The table includes the estimated water quality of the combined water (tap water and produced water from tertiary treated and internal recycle) in total dissolved solids. These cases are compared to the current situation at the site in which the site acquires all its water from the tap (the base case).

The table shows that for both RO and FO the combined use of internal recycling and tertiary treated following water treatment can significantly reduce tap water use by the site without any water quality issues. The FO system using the switchable draw solute technology is more efficient at doing so: it uses less energy that the RO under nearly similar water recovery ratios, and can exceed the highest water recovery that low pressure RO can achieve for these waste streams. In general, the use of either tertiary treated water or the use of internal recycling can reduce tap water consumption regardless of how these streams are purified. Combining the two options can significantly help reduce total water, including cases where all but a fixed minimum amount of tap water can be eliminated. In all cases, the purification of these streams will produce water that is as good if not better than tap water, and will be suitable for the industrial site.

In contrasting reverse verses forward osmosis, the forward osmosis process can obtain more water from the waste streams than reverse osmosis with lower energy expenditure. The low pressure reverse osmosis processes can only achieve up to about 85% water removal from the waste streams before the osmotic pressure of the concentrated feed stream exceeds the applied pressure. Higher hydraulic pressures can recover more water but at a higher energy cost. In contrast, the forward osmosis draw solution has a high osmotic pressure that can easily remove at least 90% of the water and potentially more. The energy to achieve this higher ratio is lower than what is required for reverse osmosis, with the 90% recovery of water from both tertiary treated and recycled streams only taking 10% of the energy that would be needed to recover 85% of the water from the same streams as with reverse osmosis. Thus, this forward osmosis water treatment system can produce clean water without the energy costs associated with reverse osmosis.

An alternate means of evaluating this data is to estimate the operating costs (OPEX) for the water treatment system. This is done using approximate costs of $0.0065/gal of tap water, $0.0029/gal of tertiary treated water (40% of the tap water costs), and the price of electricity at $0.12/kW-hr; these are values representative of the industrial site's location; the OPEX values reflect only these costs. These values are subject to change, and are used in this example to demonstrate the estimated reduced OPEX from using the switchable draw solute forward osmosis for water treatment. Table 6 lists the estimated operating costs and the savings based on current tap water usage (the base case)

From Table 6, tertiary treated water use alone is not the most effective means of cutting costs; while the use of tap water is reduced, the tertiary treated water still must be purchased. It is necessary for the effectiveness of water recovery for tertiary treated water purification to be high to make this a cost-favorable measure. Recycling does significant improve costs, and augmenting that with tertiary treated water can further improve the cost savings.

For RO systems, the better cost savings generally come from more efficient water recovery systems, but at the same time, these systems require more energy to drive the water recovery. In the case of using both tertiary treated and recycled water streams, the amount of energy needed for a high recovery process (three stages) becomes a greater cost, and as a net effect this option is less of a savings compared to using the two-stage process. There are diminishing returns here that result from the energy use in reverse osmosis. This is an additional limitation of RO systems, in addition to the maximum water recovery that RO can perform.

For switchable FO systems, the required energy is already lower than that needed for RO. The increase in energy to handle higher water recovery levels is more manageable. Greater cost savings can be obtained with highly efficient systems. Further, as noted previously, these systems can obtain higher levels of water recovery from the same waste streams than RO. Thus, switchable FO systems are well suited for handling this type of industrial waste.

### Example 5

### Integration with Other Water Treatment Units

In the same industrial site as Example 4, the waste streams are segregated into four separate wastes: general wastes, waste containing metals to be recovered before the stream is sent to sewage, waste containing cyanide to be destroyed before sewage, and wastes containing chrome (chromium (VI) oxides and related materials) that must be removed before sewage. These last two streams are a requirement by the site to make their wastewater suitable for sewage, while the metals-containing stream presents a possible revenue source.

In the embodiment of this wastewater treatment system, the forward osmosis system would need to be integrated with these upstream wastewater treatment units, since these streams have already been segregated by the industrial site. This allows the treatment or recovery processes to be done at a smaller scale (on the specific wastewater stream output rather than the entire wastewater output). Additionally, removing the quantities of metals, cyanide, and chrome prior to forward osmosis can help improve the forward osmosis process efficiency, as the removal of these components will reduce the total dissolved solids in the wastewater, reducing the osmotic pressure and allowing a more efficient wastewater recovery process. This concept is described generally by FIG. 14.

Table 7 shows an extension from the previous example, where forward osmosis is used to handle the wastewater from the industrial site accounting for both internal recycling and tertiary treated water use. This considers the case from Example 4, where the general waste stream, the stream after metals recovery, and the stream after cyanide destruction are used. Two other cases are presented; one where only the general waste stream and the post-metals recovery are treated, and one where only general wastewater is treated. The same assumptions on membrane performance from Example 4 are used here.

TABLE 7
Estimated Performance of Various Configurations of a Switchable Forward Osmosis
Water Treatment System and Other Water Treatment Systems at an Industrial Facility

| | | | | Available | Energy |
|---|---|---|---|---|---|
| | Tap | Tertiary | Tap Water | Water | Required |
| | Water | Treated | Reduction | Quality | by RO or |
| | Use | Water Use | from Base | (TDS, | FO System |
| Case | (gal/hr) | (gal/hr) | Case (%) | ppm) | (kW) |
| Base | 4172 | — | — | 120 ppm | — |
| Forward Osmosis | 714 | 2000 | 82.9% | 24 ppm | 13.4 |
| using only general | | | | | |
| wastewater | | | | | |
| Forward Osmosis | 163 | 2000 | 96.1% | 26 ppm | 15.6 |
| using general | | | | | |
| wastewater and | | | | | |
| metals recovery | | | | | |
| water post- | | | | | |
| treatment | | | | | |
| Forward Osmosis | 146 | 2000 | 96.5% | 28 ppm | 15.6 |
| using general | | | | | |
| wastewater and | | | | | |
| metals recovery and | | | | | |
| cyanide destruction | | | | | |
| wastewater post- | | | | | |
| treatment | | | | | |

The additional use of other wastewater streams can increase the effectiveness of the wastewater treatment system in its reduction of tap water, without significantly impacting the quality of the produced water. This approach allows for the parallel wastewater treatment systems to be used as a common source to the forward osmosis water treatment system, as to produce a single clean source of water which meets the internal recycling requirements for the site. Each of the individual wastewater treatment systems can be scaled to meet the capacity of those specific waste streams, as opposed to having to apply the same treatment to the overall sum of all four streams, making the overall water treatment system more efficient. Further, the reject water from the switchable forward osmosis system will be able to meet the requirements for sewage since the inlet feed streams were already stripped of regulated waste components before reaching the forward osmosis system. As with Example 4, the energy requirements for each case do include internal heat recovery within the switchable FO system, but does not include the reuse of heat generated by the site. It is expected that with many such available heat streams from the site to drive the recovery process in the switchable FO systems, the energy costs would also drop significantly.

### Example 6

### Large Scale Desalination

This example demonstrates another embodiment of this invention, using the switchable FO systems for desalination. Large-scale recovery of potable water from seawater is a highly desirable process. This representative problem is a desalination plant producing 400,000 gallons per hour (approximately 10 million gallons/day) of potable water, using seawater with a salt concentration of 3.5 wt %; the osmotic pressure of seawater at this concentration is around 28 atm. Two cases are considered, high pressure reverse osmosis using hydraulic pressures of 60 atm, and forward osmosis using the switchable draw solutes. Both cases have limiting factors based on the osmotic pressure of the feed water as it is further concentrated by the membrane process. For reverse osmosis, 60 atm is equivalent to the osmotic pressure of a 7 wt % salt water solution, which means that RO can only withdraw 50% of the water from seawater before this limit is reached. In the forward osmosis case, with trimethylamine solute, the osmotic pressure of the draw solution at 60 wt % is around 220 atm, which is equivalent to approximately a 20 wt % salt water solution. The maximum theoretical water recovery for this case is about 82%, much higher than RO's value. For purposes of demonstration, the water recovery in the switchable FO unit is assumed to be at 75%.

Each FO case includes the case where there is no available external waste heat streams, and the case where waste heat is available to make up for 80% of the total thermal requirements for the FO process. These heat streams would be expected to be readily available at a plant of this size for dissipating heat from various pumps and other process equipment units at this scale, as well as any power generation units that may be required to maintain the plant operation. For all cases, the membrane is assumed to have 98.5% salt rejection rate, which is on par with other commercial membrane units.

In both the reverse osmosis and forward osmosis cases, the option of adding an additional low-pressure RO unit as a secondary cleanup step was considered to improve the purity of the produced water. This would be necessary to meet the <500 ppm TDS secondary requirements for potable water set by the U.S. EPA. The low-pressure RO was modeled as a three-stage unit, with a single state water recovery efficiency of 50% with an operating pressure of 100 psi. The salt rejection rate for each membrane is 98.5%, following from Example 4 above. The results are shown in Table 8.

In general, the switchable forward osmosis process is more efficient than the reverse osmosis at this scale. One factor of consideration is the higher amount of contaminant in the produced water for forward osmosis. This comes from the nature of the draw solution regeneration loop, where salt that is not rejected by the membrane will build up over multiple passes. In contrast, reverse osmosis does not have a similar draw solution loop requirement, and the produced water only has a single pass through the system, so the produced water will be cleaner. The addition of the separate low-pressure RO unit is able to remove the remaining impurities with little difficulty from the forward osmosis process. Further, the makeup/blowdown processes for the switchable draw forward osmosis system would further help to alleviate salt buildup in the regeneration loop as described in the embodiment of this invention.

The overall switchable forward osmosis system is more efficient at producing clean water both on water consumption and energy basis even with the additional energy requirements for a three-stage RO unit. This is further improved when low-quality heat streams, which would be anticipated to exist in a process of this scale, can be used to supply the needed energy for the FO recovery system.

### Example 7

### Post-Desalination Switchable FO Water Treatment of Brine Reject

This is an extension of Example 6, which presents switchable FO as a replacement for large scale RO desalination systems. Full replacement of RO by FO may be an option for future desalination installations but at the present time, there are numerous large scale (greater than 1 million gallons per day) RO desalination systems already in place and planned. It is unlikely that FO will immediately displace these mature systems. Switchable FO systems still offer an opportunity to be used with existing RO systems, as they can be used to extract more water from the RO brine reject without little additional energy input. This becomes a more synergistic option if waste heat from the RO system is available for reuse in the switchable FO system.

In the case using only an RO unit (the first listed in Table 8 above), 795,000 gal/hr of seawater (3.5 wt % NaCl) are required to produce 400,000 gal/hr of clean water. The rejected seawater will have a concentration of about 7 wt % NaCl. This correlates to an osmotic pressure of about 54 atm, which cannot be readily overcome by RO without extensive capital and operating costs. The 395,000 gal/hr of brine still has a significant amount of water that can be recovered by other methods.

As shown in FIG. 15, it is possible to place switchable FO system following the RO to operate on the brine reject. With the same switchable FO draw solution described above (60 wt % TMA in its concentrated form) the draw solution will possess an osmotic pressure around 220 atm. This can effectively treat a brine stream up to 20 wt % brine, which will have an osmotic pressure around 150 atm. It is thus possible recover a theoretical maximum of 257,000 gal/hr of clean water from the switchable FO system from the 7 wt % brine outlet from the RO system before the brine is concentrated beyond 20 wt %. At this theoretical maximum, a total of 657,000 gal/hr of produced water could be obtained from 795,000 gal/hr of seawater, or an overall recovery rate of 82.6%.

This configuration benefits from heat integration with the RO and FO systems to reduce the energy requirements for the additional FO system. The switchable FO water treatment systems can utilize low-grade waste heat generated in the operation of the RO plant. Calculations were made from the previous Example 6 results to estimate the overall water recovery and energy requirements assuming waste heat reuse in the FO system. Further, the table lists the cases where a secondary low-pressure RO treatment is used to further purify the water from the RO and FO processes. Other assumptions are outlined in the previous example. These results are shown in Table 9:

TABLE 9
Estimated Performance for an RO Desalination System and for a RO Desalination System
with Additional Water Recovery by a Switchable FO System with Recovered Heat Reuse

| | | | | | Energy | |
|---|---|---|---|---|---|---|
| | | | | | Consumption | Water |
| | Seawater | Produced | | Energy | for Produced | Quality |
| | Used | Water | Water | Required | Water (kW- | (ppm |
| Case | (gal/hr) | (gal/hr) | Recovery | (kW) | hr/gal.) | TDS) |
| RO alone | 795,000 | 400,000 | 49.4% | 5,800 | 0.0145 | 89 |
| RO with | 894,000 | 400,000 | 43.6% | 7,200 | 0.0180 | <10 |
| secondary | | | | | | |
| RO | | | | | | |
| treatment | | | | | | |
| Ro with | 795,000 | 642,000 | 80.8% | 6,150 | 0.0096 | 1292 |
| post FO | | | | | | |
| brine | | | | | | |
| recovery | | | | | | |
| RO with | 795,000 | 593,000 | 74.5% | 6,850 | 0.0116 | 66 |
| post FO | | | | | | |
| brine | | | | | | |
| recovery | | | | | | |
| and | | | | | | |
| secondary | | | | | | |
| RO | | | | | | |
| treatment | | | | | | |

As shown in Table 9, there is net better water recovery with the additional FO process. Importantly, with the heat reuse within the switchable FO system, the energy requirements to obtain that additional water are small, and thus the net energy use per volume of produced water is lower. The ability to reuse waste heat in a beneficial manner is a feature of the switchable FO systems that is not available in salt-based FO systems. As described previously, the salt-based systems must use high-pressure membrane separation processes or thermal systems to remove the water from draw solution. The thermal systems in salt-based FO systems cannot use low-grade waste heat for this process. In switchable FO systems, the removal of draw solute from the draw solution to produce water can be done at lower temperatures and thus use low-grade heat from other sources, significantly reducing the net energy requirements of the process.

One aspect that also must be considered is the salinity of the produced water. Extracting water from brine with the switchable FO system will produce a water effluent stream with high salt content since the RO reject is already of high concentration. In this case it is estimated that the produced water from the combined RO and FO systems will have a salinity of nearly 1300 ppm, which may be suitable for some non-potable used but cannot be used as drinking water. Additional post-treatment, like low-pressure RO, is necessary to bring down the concentration further to less than 100 ppm, a range desirable for potable water. Even with this additional energy use, the energy cost per volume of produced water for the combined RO/FO system is less than that for the RO system alone. From this example, the use of switchable FO water treatment following an RO plant to gain additional water recovery is shown to be a beneficial configuration described by this invention.

Although the invention has been described with reference to the above examples, it will be understood that modifications and variations are encompassed within the spirit and scope of the invention. Accordingly, the invention is limited only by the following claims.

### REFERENCES

L. F. Greenlee, D. F. Lawler, B. D. Freeman, B. Marrot, P. Moulin, “Reverse Osmosis Desalination: Water Sources, Technology, and Today's Challenges”, Water Research, 43, (2009), p 2317-2348.

K. Lutchmiah, A. R. D. Verliefde, K. Roest, L. C. Rietveld, E. R. Cornelissen, “Forward Osmosis for Application in Wastewater Treatment: A Review”, Water Research, 58, (2014), p 179-197.

T. Y. Cath, A. E. Childress, “System and Methods for Purification of Liquids”, U.S. Pat. No. 8,216,474, (2012).

T. Y. Cath, N. T. Hancock, C. D. Lundin, C. Hoppe-Jones, J. E. Drewes, “A Multi-barrier Osmotic Dilution Process for Simultaneous Desalination and Purification of Impaired Water”, J. Membrane Sci., 362 (2010), p 417-426.

B. D. Coday, P. Xu, E. G. Beaudry, J. Herron, K. Lampi, N. T. Hancock, T. Y. Cath, “The Sweet Spot of Forward Osmosis: Treatment of Produced Water, Drilling Wastewater, and Other Complex and Difficult Liquid Streams”, Desalination, 333 (2014), p 23-35.

Q. Ge, M. Ling, T.-S. Chung, “Draw Solutions for Forward Osmosis Processes: Developments, Challenges, and Prospects for the Future”, J. Membrane Sci., 442, (2013), p 225-237.

R. K. McGovern, J. H. Lienhard V, “On the Potential of Forward Osmosis to Energetically Outperform Reverse Osmosis Desalination,” J. of Membrane Sci., 469, (2014), p 245-250.

D. L. Shaffer, J. R. Werber, H. Jaramillo, S. Lin, M. Elimelech, “Forward Osmosis: Where Are We Now?”, 356 (2015), p 271-284.

S. M. Mercer, P. G. Jessop, “‘Switchable Water’: Aqueous Solutions of Switchable Ionic Strength”, Chem. Sus. Chem. 3(4), (2010) p 467-470.

R. K. McGinnis, J. E. Zuback, “Forward Osmosis Separation Processes”, U.S. Patent Application 2012/0273417 (2012).

J. L. McCutcheon, R. L. McGinnis, M. Elimelech, “Ammonia-Carbon Dioxide Forward Osmosis Desalination”, Water Conditioning & Purification (October 2006).

R. L. McGinnis, M. Elimelech, “Energy Requirements of Ammonia-Carbon Dioxide Forward Osmosis Desalination”, Desalination, 207, (2007), p 370-382.

A. S. Moon, M. Lee, “Energy Consumption in Forward Osmosis Desalination Compared to other Desalination Techniques”, International Scholarly and Scientific Research & Innovation, 6(5), (2012), p 515-517.

K. Thomsen, P. Rasmussen, “Modeling of Vapor-Liquid-Solid Equilibrium in Gas-Aqueous Electrolyte Systems”, Chem. Eng. Sci., 54, (1999), p 1787-1802

C. Boo, Y. F. Khalil, M. Elimelech, “Performance Evaluation of Trimethylamine-Carbon Dioxide Thermolytic Draw Solution for Engineered Osmosis”, J. Membrane Sci., 473 (2015), p 302-309.

R. L. McGinnis, N. T. Hancock, M. S. Nowosielsky-Slepowron, G. D. McGurgan, “Pilot Demonstration of the NH₃/CO₂ Forward Osmosis Desalination Process on High Salinity Brings”, Desalination, 312 (2013), p 67-74.

P. G. Jessop, L. Phan, A. Carrier, S. Robinson, C. J. Dun, J. R. Harjani, “A Solvent Having Switchable Hydrophilicity”, Green Chem., 12 (2010), p 809-814.

M. L. Stone, C. Rae, F. F. Stewart, A. D. Wilson, “Switchable Polarity Solvents as Draw Solutes for Forward Osmosis”, Desalination, 312 (2013), p 124-129.

M. Ikeda, K. Miyamoto, “Forward Osmosis Apparatus and Forward Osmosis Process”, U.S. Patent Application 2013/02478447 (2013).

A. D. Wilson, F. F. Stewart, M. L. Stone, “Methods and Systems for Treating Liquids using Switchable Solvents”, U.S. Patent Application 2013/0048561 (2013).

P. G. Jessop, C. A. Eckert, C. L. Liotta, D. J. Heldebrant, “Switchable Solvents and Methods of Use Thereof”, U.S. Pat. No. 7,982,069 (2011).

P. G. Jessop, L. Phan, A. J. Carrier, R. Resendes, D. Wechsler, “Switchable Hydrophilicity Solvents and Methods of Use Thereof”, U.S. Pat. No. 8,580,124 (2014).

P. G. Jessop, C. A. Eckert, C. L. Liotta, D. J. Heldebrant, “Switchable Solvents and Methods of Use Thereof”, U.S. Pat. No. 8,513,464 (2013).

S. M. Mercer, T. Robert, D. V. Dixon, C-S. Chen, Z. Ghoshouni, J. R. Harjani, S. Jahangiri, G. H. Peslherbe, P. G. Jessop, “Design, Synthesis, and Solution Behaviour of Small Polyamines as Switchable Water Additives”, Green Chem., 14 (2012), p 832-839.

P. G. Jessop, S. M. Mercer, T. Robert, R. S. Brown, T. J. Clark, B. E. Mariampillai, R. Resendes, D. Wechsler, “Systems and Methods for Use of Water with Switchable Ionic Strength”, U.S. Patent Application 2014/0076810 (2014).

D. S. Wendt, C. J. Orme, G. L. Mines, A. D. Wilson, “Energy Requirements of the Switchable Polarity Solvent Forward Osmosis (SPS-FO) Water Purification Process”, Desalination, 374, (2015), p 81-91.

G. T. Gray, J. R. McCutcheon, M. Emilelech, “Internal Concentration Polarization in Forward Osmosis: Role of Membrane Orientation”, Desalination, 197 (2006) p 1-8.

K. Y. Wang, R. C. Ong, T.-S. Chung, “Double-Skinned Forward Osmosis Membranes for Reducing Internal Concentration Polarization within the Porous Sublayer”, Ind. Eng. Chem. Res., 49(10), (2010), p 4824-4831.

Y. H. Hui (editor), Handbook of Food Science, Technology, and Engineering, Vol. 4, CRC Press, (2006) p 191-10

D. S. Wendt, C. J. Orme, G. L. Mines, A. D. Wilson, “Energy requirements of the switchable polarity solvent forward osmosis (SPS-FO) water purification process”, Desalination, 374, p 81-91 (2015).

S. Khuntia, S. K. Majumder, P. Ghosh, “Microbubble-aided Water and Wastewater Purification: A Review”, Rev. Chem. Eng., 28(4-6), (2012), p 191-221.

P. Nicoll, “Solvent Removal”, U.S. Patent Application 2012/0279921 (2012).

T. Y. Cath, A. E. Childress, C. R. Martinetti, “Combined Membrane-Distillation-Forward-Osmosis Systems and Methods of Use”, U.S. Pat. No. 8,029,671 (2011).

J. R. Vanderveen, K. J. Durelle, P. G. Jessop, “Design and evaluation of switchable-hydrophilicity Solvents”, Green Chem. 16, p 1187-1197 (2014).

1. A water treatment system which operates on one or more impure water sources to produce one or more purified water effluents, utilizing one or more water treatment sub-systems including at least one water treatment system based on a forward osmosis process which includes:
a) an aqueous draw solution using a draw solute that become highly soluble and ionic on the addition of an ionizing agent, and becomes insoluble and non-ionic on the dissociation of the ionizing agent (a switchable draw solute or solvent);
b) a membrane process where impure feed solution contacts one side of at least one semi-permeable membrane, and the concentrated draw solution contacts the other side, and which water is drawn through the membrane from the feed solution into the draw solution through the difference in osmotic pressure between the draw and feed solution;
c) a recovery process where the diluted draw solution following the membrane process is treated to dissociate the ionizing agent from the draw solute, and subsequently remove the draw solute and the ionizing agent from the water, generating a clean water stream;
d) a regeneration process where the recovered draw solute and ionizing agent are reintroduced into aqueous solution, generating a concentrated draw solution prior to the membrane process; and
e) a control system that monitors and controls the individual processes within the forward osmosis water treatment sub-system.

2. The system of claim 1, where the impure water sources have a total dissolved solids (TDS) concentration of at least 0.1 wt %, and more preferably at least 1.0 wt %, and most preferably of at least 3.0 wt %.

3. The system of claim 1, where the feed water sources include but are not limited to: greywater, brackish water, seawater, surface and groundwater including impaired and polluted sources, brine, high-salinity bodies of water, secondary and tertiary treated wastewater (also commonly referred to as recycled water, reclaimed water or “purple pipe” water), biomass, municipal solid waste and associated leachate, pharmaceutical, food/beverage, and industrial process streams (for the processing and removal of water), industrial and commercial wastewater, agriculture, and produced water from oil & gas (hydro-fracturing), geothermal, and from mining operations.

4-7. (canceled)

8. The system of claim 1, where the draw solute in its non-ionic form has a solubility in water less than 0.1 g/mL, and more preferably, less than 0.0001 g/mL, and in its ionic form upon association with the ionizing agent, a solubility greater than 1000 g/mL.

9. The system of claim 1, where the draw solute has a molecular weight greater than 31.

10. The system of claim 9, where the draw solute is an amine of the general faun R1R2R3N, or an amidine of the general form R1-C(═NR2)—NR3R4), or a guanidine of the general form R1R2-C(═NR3)—NR4R5).

11-26. (canceled)

27. The system of claim 1, where the ionizing agent has a molecule weight greater than 31.

28. The system of claim 27, where the ionizing agent is a gas in pure form at standard ambient conditions (25° C., 1 atm).

29. (canceled)

30. The system of claim 28, where the ionizing agent is one of: CO2, CS2, COS, NO2, or SO2, or a mixture of these gases.

31-37. (canceled)

38. The system of claim 1, where the concentrated draw solution has an osmotic pressure of at least 100 atm, and more preferably at least 200 atm, and most preferably at least 400 atm.

39. (canceled)

40. The system of claim 1, where the membrane system consists of at least one semi-permeable membrane.

41-51. (canceled)

52. The system of claim 1, where the membrane system consists of two or more membranes, of one or more types identified under claim 40.

53-58. (canceled)

59. The system of claim 52, where the membranes are arranged in a combination of serial and parallel configurations.

60-62. (canceled)

63. The system of claim 52, where the forward osmosis water treatment sub-system's control system monitors the individual sensors on the feed and draw solution streams, and can use valves to isolate or bypass membranes in response to changes in monitored properties.

64. The system of claim 1, where the recovery process consists of one or more process units to dissociate the draw solute from the ionizing agent in the diluted draw solution, and separate both from the water.

65-95. (canceled)

96. The system of claim 1, where prior to or immediately following the regeneration system is a blowdown vent to exhaust a fraction of the draw solution and a means of providing makeup draw solution.

97-102. (canceled)

103. The system of claim 1, where some or all of the recovery process is physically integrated with some or all of the regeneration process as to transfer the heat generated by the regeneration process directly to the recovery process.

104. The system of claim 1, where some or all of the membrane process is physically integrated with some of all of the recovery process as to create a hybrid separation system consisting of three fluid areas, the feed solution, the draw solution, and the permeate stream, with a forward osmosis membrane separating the feed and draw solution, and a second membrane separating the draw solution and permeate stream.

105-111. (canceled)

112. The system of claim 1, where the control system monitors and records sensors located on the feed water inlets, draw solution loop, and produced water outlets.

113-126. (canceled)

127. The system of claim 1, where the forward osmosis water treatment sub-system is operated in a configuration with at least one other water treatment sub-system, which includes but are not limited to: additional switchable FO sub-systems; non-switchable FO sub-systems; RO sub-systems; filtration sub-systems (including particulate filtration, microfiltration, ultrafiltration, and nanofiltration); evaporative and distillation sub-systems, membrane distillation and hybrid membrane sub-systems; chemical treatment, capture, and destruction sub-systems; ion exchange sub-systems; biological treatment and destruction sub-systems; ultra-violet treatment sub-systems; advanced oxidation treatment systems, settling tank sub-systems; and anti-scaling sub-systems.

128-147. (canceled)
